(19) United States
(12) Patent Application Publication
(10) Pub. No.: US 2018/0277132 A1
(43) Pub. Date: Sep. 27, 2018

(54) SYSTEMS AND METHODS FOR INCREASING LANGUAGE ACCESSABILITY OF MEDIA CONTENT

(71) Applicant: Rovi Guides, Inc., San Carlos, CA (US)

(72) Inventor: Violet LeVoit, Philadelphia, PA (US)

(21) Appl. No.: 15/464,996

(22) Filed: Mar. 21, 2017

(51) Int. Cl. G10L 21/007; G10L 25/57; G10L 15/02; G10L 15/26

(52) U.S. Cl. CPC G10L 21/007; G10L 25/57; G10L 2015/025; G10L 15/265; G10L 15/02

(57) ABSTRACT

Systems and methods are described for increasing the language accessibility of media content by modifying accents in speech. For example, a particular character in a media asset may speak in a dialect (e.g., British English) that is difficult for some listeners to understand. The systems and methods, after detecting the dialect of the speech of the particular character, may determine a user preference for an amount to adjust the dialect toward another dialect that the user more easily understands (e.g., American English). For example, specific phonemes and/or words may be modified because they are different between the two dialects, while others may not need to be modified. The systems and methods replace phonemes and/or words determined to need modification with phonemes and/or words that are intermediate between the two dialects.

### BACKGROUND

Modern consumers of media content are able to consume media content from a variety of countries and in a variety of languages and/or dialects. However, users who are not fluent in a language and/or dialect of a given media content may require assistance in order to understand what is occurring in the media content. In many instances, content providers provide subtitles in different languages and/or dialects so that users from a wider variety of locations can enjoy the media content. However, subtitles are intrusive in that they are overlaid on portions of the media content itself, which many consumers may find distracting. To address this, some conventional systems provide dubbed versions of media content. Furthermore, in some cases where a dubbed version is not available, some conventional systems analyze and replace phonemes of one dialect with those of another. However, wholesale replacement of phonemes and/or words spoken by a character in media content in many cases leads to audio that sounds unbelievable coming from the character as the characteristics of the character's voice are lost when phonemes and/or words are replaced.

### SUMMARY

Accordingly, systems and methods are described herein for increasing the language accessibility of media content by modifying accents in speech. For example, a particular character in a media asset may speak in a dialect (e.g., British English) that is difficult for some listeners to understand. The systems and methods, after detecting the dialect of the speech of the particular character, may determine a user preference for an amount to adjust the dialect toward another dialect that the user more easily understands (e.g., American English). For example, specific phonemes and/or words may be modified because they are different between the two dialects, while others may not need to be modified. The systems and methods replace phonemes and/or words determined to need modification with phonemes and/or words that are intermediate between the two dialects. In this way, the systems and methods retain some of the characteristics of the original speech of the character while allowing a user to more easily comprehend the speech.

In some aspects, a media guidance application may determine that audio contains human speech. For example, the media guidance application may analyze audio characteristics, such as the amplitude and frequency of an audio file at given time points and compare with a rule-set for determining whether human speech is present at each time point. Specifically, the rule-set may contain particularly frequencies that correspond to human speech, audio fingerprints, etc. that can be compared to the audio characteristics of an audio file at a given time. The media guidance application may analyze the audio file of a media asset in real-time, prior to selection by a user, or at any other time. For example, the media guidance application may access a database containing time codes when human speech occurs in a media asset (e.g., the analysis occurs before the user selects the media asset). In this situation, the media guidance application may save computational resources by not having to re-analyze audio that has been analyzed previously (e.g., by a server, or another media guidance application).

The media guidance application may analyze the human speech to determine a first accent type of the human speech. For example, the media guidance application may further analyze a segment of audio in a media asset containing human speech to determine a particular accent type of the human speech. For example, the characteristics of a segment in the audio of a media asset containing human speech may be compared to audio fingerprints of a variety of dialects in different languages to determine an accent type of the speaker. In some embodiments, the media guidance application may utilize constraints to focus the search on more probable accent types. For example, in a movie in English, the media guidance application may search for only English accent types. Alternatively or additionally, the media guidance application may search through metadata associated with the media asset to determine a probable accent type. For example, a movie about hockey is likely to contain a Canadian accent.

In some embodiments, the media guidance application may access a database containing accent types of human speech that begins at particular time codes to determine the first accent type. Specifically, the media guidance application may retrieve, from the audio containing the human speech, a time code corresponding to a start time of the human speech. For example, the media guidance application may determine from a first time code that the current progress point in a media asset is thirty minutes from the beginning of the media asset. The time code may be a numerical representation of the number of frames of the media asset presented at a particular point in time. For example, the media guidance application may retrieve the time code (00:30:00:00) corresponding to (hour:minute:second:frame). The media guidance application may determine that at that time code, human speech is occurring based on comparing the time code with a plurality of time codes in a database, or based on analyzing characteristics of the audio at that time code, as described above. The media guidance application may compare the time code to a plurality of time codes stored in a database, wherein each time code of the plurality of time codes stored in the database is associated with an accent type of a plurality of accent types. For example, the database may contain an identifier of what accent and/or language the human speech is. In some embodiments, the database may additionally contain an indication that human speech is present at a particular time code (e.g., a Boolean value). The media guidance application may compare the value for the time code (e.g., 00:30:00:00) with values stored in the database to determine a match.

The media guidance application may determine that the time code matches a first time code stored in the database. For example, the media guidance application may determine that a time code from the audio matches a stored time code in the database. In some embodiments, if the time code is within a threshold (e.g., 1 second) of a time code in the database a match is determined. The media guidance application may then retrieve the first accent type from a field associated with the first time code. For example, the database may be structured as a table where each row contains a field with a time code in the audio and another field containing an identifier of the first accent type being spoken at that time in the audio. As a specific example, the media guidance application may retrieve a value of “Canadian English” as the first accent type being spoken at a particular time.

In some embodiments, the media guidance application may determine the first accent type based on comparing a phoneme or subset of phonemes of the audio with corresponding phonemes of different accent types. Specifically, the media guidance application may compare the audio properties of a first phoneme of the series of phonemes with the audio properties of a respective corresponding phoneme of each accent type of a plurality of candidate accent types. For example, the media guidance application may partition the audio into phonemes completely as described below, or selectively partition one or a few phonemes for the purposes of comparison with corresponding phonemes to determine the first accent type. The media guidance application may determine a corresponding phoneme based on a speech-to-text algorithm and a mapping of the phoneme to a plurality of phonemes of different accent types stored in a database. The media guidance application may then compare the audio properties (e.g., the amplitude and frequency or frequencies present at particular points in time) of the first phoneme with corresponding phonemes of different accent types. The media guidance application may determine, based on comparing the first phoneme with the respective corresponding phoneme of each accent type, a similarity value between the first phoneme and the respective corresponding phoneme of each accent type. For example, the media guidance application may determine that a first phoneme “ah” (e.g., based on the speech-to-text algorithm) is 50% similar based on the audio characteristics to the corresponding phoneme for “ah” in Canadian English, and 90% similar to the corresponding phoneme in British English.

The media guidance application may rank the similarity value between the first phoneme and the respective corresponding phoneme of each accent type. For example, the media guidance application may determine that since 90% similar is greater than 50% similar, the British English accent should be ranked higher than the Canadian English accent. The media guidance application may, based on the ranking, determine the first accent type that corresponds to the human speech. For example, since the phoneme of British English accent type had a higher ranked similarity to the phoneme in the audio, the media guidance application may determine that the first accent in the audio is British English. The media guidance application may compare multiple phonemes in order to increase the certainty of the determined first accent type. For example, if the media guidance application determines that four phonemes of the audio correspond to British English as the highest ranked accent type, then the media guidance application may provide a higher confidence rating in the first accent type. The higher confidence rating may be factored by the media guidance application when determining an amount to adjust the audio. In some embodiments, the media guidance application may store an indication that the first accent type of the human speech begins at a specific time (e.g., associated with a time code when it begins) such that the accent type can be more quickly determined in the future.

The media guidance application may compare the first accent type of the human speech with preferences stored in a user profile. For example, the media guidance application may retrieve a user profile associated with a user (e.g., consuming a media asset) from storage or a remote server. The media guidance application may then retrieve stored characteristics and preferences of the user and determine whether they relate to the first accent type. For example, the media guidance application may determine that the user's native accent type is American English from a user preference, which is different than the detected accent type (e.g., Canadian English). In some embodiments, the media guidance application may access a data structure storing user preferences related to how easily a user understands different accent types (e.g., values ranking on a scale of 1 to 10 how well a user understands different accents). Values stored in the data structure may correspond to the amount to adjust the first accent type, discussed further below.

The media guidance application may, based on the preferences stored in the user profile, determine an amount to adjust the first accent type to a second accent type. For example, the preferences may contain a value or indication of the amount to adjust the first accent type to a second accent type. As a specific example, the media guidance application may retrieve a value of 2 out of 10 that a user can understand a particular accent and based on the value determine an amount to adjust the audio (e.g., to be more like the user's accent type). The media guidance application may determine the amount based on a rule-set. For example, the media guidance application may store average values for how easily users who identify with one accent type can understand the detected accent type in the media asset. For example, based on a user's geographic location, demographics, or other stored information in their profile, the media guidance application may determine a probable accent type for the user. The media guidance application may then determine the amount based on the probable accent type of the user (e.g., from a data structure containing a plurality of average values for amounts to adjust the audio from one accent type to another). The media guidance application may then adjust the audio from the detected accent type to the probable accent type of the user by the amount.

In some embodiments, the media guidance application may determine an amount to adjust the first accent type to the second accent type based on comparing user preferences with a database storing amounts to adjust accent types. Specifically, the media guidance application may retrieve the user profile. For example, the media guidance application may retrieve the user profile from storage or a remote server. The user profile may be specific to a user (e.g., Tom) or a user device (e.g., a particular set-top box). The media guidance application may retrieve, from the user profile, a value indicating that a first preference of the preferences stored in the user profile is for the second accent type. For example, the media guidance application may retrieve the user's geographic location, demographics, or other stored information in their profile, and may determine a probable accent type for the user as the second accent type. The media guidance application may also retrieve an indication of a user's preferred accent type stored in the user profile as the second accent type, e.g., “American English.”

The media guidance application may access a data structure in the user profile containing a plurality of amounts to adjust accent types to the second accent type. For example, the data structure may be organized as a table where each row contains a field with an identifier of the first accent type, another field with an identifier of the second accent type, and another field with a value for the amount to adjust the first accent type to the second accent type. The media guidance application may search the data structure to determine an amount that corresponds to the particular first accent type and second accent type. For example, the media guidance application may retrieve a value of 70 (e.g., representing 70%) from a field associated with fields for a first accent type of Canadian English and a second accent type of American English.

The media guidance application may partition the human speech into a series of phonemes. For example, the media guidance application may subdivide the audio containing human speech into smaller sections such that each section contains a single phoneme of a word. The media guidance application may determine where (e.g., at which time codes) to subdivide the audio based on characteristics of the audio indicating that a phoneme has ended and/or a new phoneme has started. Specifically, the media guidance application may analyze the audio (e.g., frequencies and/or amplitude as a function of time) to determine times that correspond to a change between two phonemes. Based on this analysis, the media guidance application may generate short audio clips for each phoneme spoken in the human speech, which may then be modified as discussed below.

In some embodiments, the media guidance application may partition the audio into shorter segments containing single phonemes based on the amplitude of the audio at particular times. Specifically, the media guidance application may analyze amplitude of the audio that contains the human speech. For example, the media guidance application may determine local minima (e.g., corresponding to a speaker making a new sound corresponding to a new phoneme) that are present in the audio stream. As another example, the media guidance application may analyze when the amplitude changes drastically (e.g., based on the second derivative of the envelope), and/or when it is below a threshold. The threshold may be an absolute amplitude, or may be relative to an earlier value (e.g., 50% less than the most recent local maximum). In some embodiments, the media guidance application may filter the audio to avoid beats and/or other factors that may make determining the amplitude at different times difficult and/or may analyze the envelope of the audio. The media guidance application may determine time codes in the audio where the amplitude is below a threshold amplitude. For example, the media guidance application may generate a data structure (e.g., a list or array) of time codes where the amplitude is below the threshold amplitude for the audio. The media guidance application may determine that between each two successive time codes in the data structure a single phoneme is spoken. The media guidance application may extract segments of the audio between consecutive ordered time codes of the determined time codes, wherein each extracted segment includes a phoneme of the series of phonemes. For example, the media guidance application may store audio clips extracted from the audio between the determined time codes in storage (e.g., local or at a remote server).

The media guidance application may analyze audio properties of each phoneme of the series of phonemes. For example, for each phoneme, the media guidance application may analyze the frequency or frequencies present as a function of time, amplitude as a function of time, total length, envelope, or other properties of the audio. The media guidance application may store these properties (e.g., in storage or at a remote server) in order to compare the properties of each phoneme in the media asset (e.g., containing human speech) of the first accent type to phonemes of the second accent type.

The media guidance application may determine, based on the audio properties of each phoneme of the series of phonemes, a respective similarity for each phoneme of the series of phonemes, the respective similarity indicating a percent similarity between each phoneme of the series of phonemes and a corresponding phoneme of the second accent type. For example, the media guidance application may compare the audio properties of each phoneme with candidate phonemes of the second accent type and determine which of the candidate phonemes corresponds to each phoneme of the series of phonemes and how similar the two phonemes are. For example, the media guidance application may iteratively retrieve and compare (e.g., via a program script utilizing a for-loop) each phoneme of the series of phonemes with candidate phonemes of the second accent type. The media guidance application may compare the audio properties of each phoneme with each candidate phoneme and calculate a similarity value. For example, if the amplitude of the sound wave for two phonemes varies by less than 5% over the entire length of the phoneme, it may be an indication that the two are closely related and the media guidance application may assign a high similarity value. Similarly, other audio properties may be compared and similarity values assigned based on a rule-set. Alternatively or additionally, the media guidance application may determine a phoneme of the second accent type that corresponds to each phoneme based on executing a speech-to-text algorithm and mapping the determined text of the phoneme to a corresponding phoneme of the second accent type (e.g., based on a data structure), as discussed further below. The media guidance application may store similarity values for each phoneme of the series of phonemes with a corresponding phoneme of the second accent type in a list or other data structure (e.g., stored locally or remote at a server) in order to determine which phonemes to modify.

In some embodiments, the media guidance application may determine the corresponding phoneme of a second accent type based on a textual representation of a phoneme of the series of phonemes. Specifically, the media guidance application may determine a textual representation of each phoneme of the series of phonemes. For example, the media guidance application may execute a speech-to-text algorithm that analyzes the audio characteristics of each phoneme and determines a textual representation of each phoneme, e.g., “ah.” For example, the speech-to-text algorithm may utilize a Hidden Markov Model, neural network (e.g., a deep feedforward neural network), or other models useful for processing speech (e.g., each phoneme) and determining a textual equivalent. The media guidance application may access an accent database, wherein the accent database contains a first plurality of fields each containing the textual representation of a phoneme of the first accent type, wherein each of the first plurality of fields is associated with a field of a second plurality of fields containing the textual representation of a phoneme of the second accent type. For example, the accent database may be structured as a table with a plurality of fields with identifiers of phonemes of the first accent type, where each field is linked to a field with an identifier of a phoneme for the second accent type. For example, the link may be a pointer to a field with the British English phoneme for “ah” from a field for the American English phoneme for “ah”. The media guidance application may compare the textual representation for a phoneme from the series of phonemes with each phoneme in the accent database for the first accent type (e.g., American English) to determine a match with a stored identifier of a phoneme. The media guidance application may execute a function (e.g., utilizing a for-loop) to iteratively compare each phoneme of the series of phonemes with phonemes in the accent database.

The media guidance application may determine, based on comparing the textual representation of each phoneme of the series of phonemes with the first plurality of fields, a first respective field of the first plurality of fields that matches the textual representation of each phoneme of the series of phonemes. For example, the media guidance application may determine a stored identifier of a phoneme of the first accent type that matches the textual representation of each phoneme in the series of phonemes. The media guidance application may retrieve the textual representation of the phoneme of the second accent type corresponding to each phoneme of the series of phonemes from a second respective field of the second plurality of fields, wherein each second respective field is associated with a first respective field. For example, the media guidance application may retrieve the identifier of the textual representation of each phoneme from a field associated with the matched field of the first plurality of fields. The media guidance application may then retrieve audio of the corresponding phoneme from another database that matches the identifier of the phoneme retrieved from the field of the second plurality of fields (e.g., the corresponding phoneme of the second accent type). In some embodiments, the respective field of the second plurality of fields may be associated with a link (e.g., a pointer) to a location (e.g., in storage or at a remote server) where audio associated with a phoneme of the second accent type that corresponds to a phoneme of the first accent type is located.

In some embodiments, the media guidance application may determine the similarity between a phoneme of the first accent type and a corresponding phoneme of the second accent type by comparing the frequency and amplitude as functions of time. Specifically, the media guidance application may compare the audio properties of each phoneme of the series of phonemes with the corresponding phoneme of the second accent type by generating, based on analyzing the audio properties of each phoneme of the series of phonemes, first values for frequency and amplitude as functions of time for each phoneme of the series of phonemes. For example, the media guidance application may generate a data structure (e.g., a list, table, or array) for each phoneme and populate the data structure with particular critical values of the amplitude and frequency at particular times. For example, the media guidance application may store, for audio of each phoneme, inflection points, local and global minima and maxima, values and times when particularly large changes occurred in the amplitude and/or frequency etc. in order to generate a fingerprint of the audio for quicker and easier comparison. The media guidance application may compare the first values for each phoneme of the series of phonemes with second values for the corresponding phoneme of the second accent type. For example, the media guidance application may store (e.g., local in storage or remote at a server) a data structure containing similar information (e.g., the critical values) for each corresponding phoneme of the second accent type. The media guidance application may compare the values (e.g., the critical values stored in the data structures) by retrieving corresponding values (e.g., the maximum slope of amplitude as a function of time for audio of both phonemes) from each data structure and determining a difference between the two values.

The media guidance application may determine a degree to which the first values and the second values correspond. For example, based on the comparison, the media guidance application may determine an average difference between corresponding values of each phoneme of the series of phonemes of the first accent type with a corresponding phoneme of the second accent type. For example, the average difference may be a sum of the difference between the values, which may be weighted in some embodiments. The media guidance application may then determine the respective similarity for each phoneme of the series of phonemes based on the degree. For example, the media guidance application may assign a similarity to each phoneme of the series of phonemes based on the average difference between the values. In some embodiments, certain critical points may be more indicative of similarity between two phonemes than others and may be weighted more highly when determining the similarity. The similarity may be determined based on comparing the average difference or any other measure determined from the comparison of the values of two phonemes with a data structure containing similarity values (e.g., percentages) associated with particular average differences and/or other values determined based on the comparison.

The media guidance application may then compare the respective similarity for each phoneme of the series of phonemes to the amount. For example, the media guidance application may, based on the amount, determine that phonemes that are above a threshold similarity between the two accent types do not need to be modified, but phonemes that are below the threshold similarity need to be modified such that a newly generated phoneme is above the threshold similarity. The threshold similarity may be determined by the media guidance application based on the amount. For example, a stored user preference indicating that the user understands a certain accent 2 out of 10, with 10 being complete understanding, may correspond to a threshold similarity of 80%. The media guidance application may retrieve a mapping of the amount to threshold similarity from storage or from a remote server. The mapping may be any mathematical function that processes the amount as an input and outputs the threshold similarity. In some embodiments, the amount may be the threshold similarity.

The media guidance application may, based on comparing the respective similarity for each phoneme of the series of phonemes to the amount, determine a subset of phonemes of the series of phonemes to adjust. For example, the media guidance application may access a stored data structure (e.g., in storage or at a remote server) including an identifier of each phoneme of the series of phonemes and the similarity value for each phoneme of the series of phonemes with the corresponding phoneme of the second accent type. The data structure may also contain an identifier of the corresponding phoneme. The identifiers may be text describing the sound of the phoneme (e.g., “boo”), and/or a pointer to a location where the audio of the phoneme is stored. The media guidance application may iteratively retrieve and compare each similarity value to a threshold value to determine whether to adjust each phoneme, as described above. For each phoneme determined by the media guidance application to need adjusting, the media guidance application may add the identifier to a list or other suitable data structure (e.g., an array or table) containing each phoneme that needs to be adjusted. The media guidance application may also add to the data structure a percentage that each phoneme needs to be adjusted based on the amount. In some embodiments, the media guidance application may adjust phonemes while continuing to determine phonemes that need to be adjusted (e.g., the operations occur in parallel). For example, when a phoneme is determined to need adjustment (e.g., to be more similar to the second accent type so the user can understand the phoneme), that phoneme may be adjusted immediately as opposed to added to a list (e.g., the subset) and adjusted in a batch process after every phoneme that needs adjustment is determined.

The media guidance application may retrieve replacement audio for each phoneme of the subset of phonemes, wherein the replacement audio replaces each phoneme of the subset of phonemes with a new phoneme with the similarity greater than the amount, and wherein the similarity is less than complete similarity with the corresponding phoneme of the second accent type. For example, the media guidance application may generate a new phoneme based on combining a phoneme from the audio (e.g., in a media asset) and the corresponding phoneme of the second accent type. As a specific example, a Canadian English accent for the word about may correspond to the phonemes, “ah” and “boot.” If the second accent type is for American English, then the phonemes for about may be, “ah” and “bowt.” The media guidance application may determine that the first “ah” phonemes are similar, but that the second needs to be modified. The media guidance application may blend the two phonemes together, by percentages based on the amount (e.g., as described further below) in order to create a new phoneme that has characteristics of the original phoneme in the audio but is easier for the user to understand. Alternatively or additionally, the media guidance application may retrieve a pre-generated phoneme that contains characteristics of the first and second accent type. For example, the media guidance application may access a database of audio of phonemes, as described further below. The media guidance application may retrieve a phoneme that is more similar to the second accent type, but still contains characteristics of the first accent type, from the database.

In some embodiments, the media guidance application may generate a new phoneme by combining audio of a phoneme of the first accent type and a phoneme of the second accent type. Specifically, the media guidance application may retrieve a corresponding phoneme of the second accent type for each phoneme of the subset of phonemes. For example, the media guidance application may retrieve audio of a corresponding phoneme of each phoneme in the subset of phonemes. The media guidance application may retrieve the audio from storage or from a remote server. The media guidance application may retrieve the appropriate corresponding audio by searching a plurality of stored audio clips each with an identifier for an audio clip that matches an identifier of each corresponding audio (e.g., “Am_En_ah” for the phoneme “ah” in American English). The media guidance application may align a first audio clip of each phoneme of the subset of phonemes with a second respective audio clip of the corresponding phoneme of the second accent type. For example, because different speakers may have spoken the phoneme in the first accent type and the corresponding phoneme in the second accent type, simply merging the two audio clips may result in unintelligible audio since the features of the audio waves (e.g., frequencies and amplitudes) don't line up and will interfere. To correct this, the media guidance application may shorten or lengthen one of the audio clips such that they are the same length and also align critical points (e.g., the global maximum of one audio clip may be at 1 second and another may be at 1.5 seconds). The media guidance application may additionally correct for pitch differences between the two audio clips such that the new phoneme that is generated does not sound like two different voices.

The media guidance application may generate the new phoneme replacing each phoneme of the subset by determining, based on the determined respective similarity for each phoneme of the series of phonemes indicating the percent similarity between each phoneme of the series of phonemes and the corresponding phoneme of the second accent type, a mixing value for each phoneme of the subset of phonemes. For example, after aligning the audio clips of the phonemes, the media guidance application may generate a new phoneme that is a composite of the two audio clips. The weighting (e.g., percentage) of each audio clip that is mixed into the new audio clip may be based on the amount. For example, the media guidance application may determine that the similarity of a particular phoneme of the subset with a corresponding phoneme is very close to being greater than the amount and thus only a small percentage of the audio clip of the corresponding phoneme of the second accent type (e.g., 10%) needs to be added so that the user can understand the audio. However, if the particular phoneme of the subset is far below the amount, then the media guidance application may mix a greater percentage of the audio clip of the corresponding phoneme of the second accent type (e.g., 10% original phoneme of the first accent type, 90% corresponding phoneme of the second accent type). The media guidance application may combine the first audio clip of each phoneme of the subset of phonemes with the second respective audio clip of the corresponding phoneme of the second accent type, wherein the first audio clip is scaled by the mixing value. For example, the media guidance application may merge the two aligned audio clips into a single audio clip. The media guidance application may perform pitch modulation, smoothing, time-scaling, and any other audio processing algorithms to ensure that the audio clips are combined to forma cohesive new audio clip.

In some embodiments, the media guidance application may retrieve replacement audio from a database. Specifically, the media guidance application may access a database containing a plurality of replacement audio, wherein each replacement audio of the plurality of replacement audio is associated with a similarity between the first accent type and the second accent type. For example, the media guidance application may access the database in storage or at a remote server (e.g., via a communication network). For example, the database may be a table and may be organized such that each row of the table contains a field for the similarity and an associated field with a pointer to a location of the replacement audio. As a specific example, the database may contain rows where the similarity between a particular phoneme of the first accent type and a corresponding phoneme of the second accent type of 50%, 60%, 70%, and 80%. In some embodiments, each row additionally contains a textual representation of the phoneme. In other embodiments, the media guidance application accesses an index data structure that points to specific table for each particular phoneme of the first accent type.

The media guidance application may retrieve, from the database, replacement audio for each phoneme of the subset of phonemes, wherein each replacement audio corresponds to a similarity that is greater than the amount. For example, the media guidance application may determine that a phoneme “ah” in the first accent type has a similarity of 60% with a corresponding phoneme of the second accent type. The media guidance application may further determine that in order to exceed the amount (e.g., so that the user can understand the phoneme) a similarity of 80% is needed. The media guidance application may compare the similarity that is needed for the replacement audio (e.g., 80%) with similarities stored in the database for the particular phoneme. Upon determining a match, the media guidance application may retrieve audio from a location (e.g., by accessing the location in memory identified by a pointer in a field associated with the similarity that is matched) either in local storage or remote at a server. The media guidance application may execute a program script (e.g., utilizing a for-loop) to iteratively retrieve replacement audio that is greater than the amount for each phoneme of the subset.

The media guidance application may transmit the replacement audio for playback. For example, upon retrieving replacement audio for each phoneme determined to need adjustment by the media guidance application, the media guidance application may transmit the replacement audio instead of each phoneme that was adjusted. For example, the media guidance application may transmit the audio of the partitioned phonemes (e.g., ordered by time code), but transmit replacement audio instead of the original partitioned phoneme for any phoneme that was adjusted.

In some embodiments, the media guidance application reassembles the audio into a single file prior to transmission for playback. For example, the media guidance application may combine the replacement audio for each phoneme with the original audio for phonemes that were determined by the media guidance application to not need to be adjusted. The media guidance application may perform pitch-correction, time-scaling, and/or any other audio processing methods to combine replacement audio with the original audio (e.g., original phonemes). In this manner, the media guidance application generates an audio track that is customized for the user to better understand an accent type in the audio, while ensuring that the replacement phonemes do not sound unnatural with the original audio (e.g., phonemes that were not adjusted).

In some embodiments, the media guidance application may generate an interactive dial for display that indicates the amount the first accent type is being adjusted to the second accent type and allows the user to change the amount. Specifically, the media guidance application may generate for display an interactive dial, wherein the interactive dial indicates the amount to adjust the first accent type to the second accent type. For example, the interactive dial may be shaped as an arc or semicircle where the end points represent audio that is completely of the first accent type and audio that is completely of the second accent type. The dial may contain images (e.g., an image of the character speaking) to inform the user what the dial refers to. The dial may contain an indicator (e.g., a line) that shows the current amount that the audio is being adjusted. The dial may also optionally contain a specific indication of the amount (e.g., text stating “70%”). In some embodiments, multiple dials may be generated for display concurrently if multiple characters speaking in different accent types are speaking at similar times. In other embodiments, multiple dials may be generated for display if multiple users are viewing the media asset, including an indication of which user the dial represents. In this embodiment, each user may listen to the audio generated specifically for them using headphones, or the amounts may be averaged and the same audio is transmitted to the users.

The media guidance application may receive a user input to adjust the amount to be more similar to one of the first accent type and the second accent type. For example, the media guidance application may receive a user input using a user input interface (e.g., a remote control) to change the amount. For example, the user may determine that the amount that the speech is currently being adjusted is not sufficient for the user to understand the speech and the user inputs a command to increase the amount toward the second accent type. The media guidance application may, based on receiving the user input, update the amount to adjust the first accent type to the second accent type. For example, the media guidance application may determine additional phonemes in the series of phonemes to adjust based on the updated amount. In some embodiments, the media guidance application may update a user profile of the user by storing the updated amount for adjusting audio with speech of the first accent type.

The described systems and methods allow for increased accessibility of speech in audio to users who may have trouble understanding particular dialects. Conventional systems may provide substitute audio and/or subtitles to allow a user to understand speech more easily. However, both subtitles and substitute “dubbed” audio may obscure the media asset and/or feel out of place to a user. The described systems and methods, by retaining characteristics of the original audio while making the audio easier to understand, allow a user to understand both the words being spoken as well as retain the natural dialect of the speaker. Specifically, the described systems and methods may generate replacement audio to replace audio of particular phonemes that are determined to be difficult to understand for a given user. In this way, the described systems and methods may increase the accessibility of speech in audio for particular users while not obscuring the media asset by replacing the audio with completely new audio.

It should be noted the systems and/or methods described above may be applied to, or used in accordance with, other systems, methods and/or apparatuses described in this disclosure.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a system modifying speech in a media asset, in accordance with some embodiments of the disclosure;

FIG. 2 shows two illustrative examples of retrieving replacement audio for a phoneme, in accordance with some embodiments of the disclosure;

FIG. 3 shows an illustrative example of a display screen including a user interface for adjusting an amount that audio in a media asset is modified, in accordance with some embodiments of the disclosure;

FIG. 4 shows an illustrative example of a display screen for use in accessing media content in accordance with some embodiments of the disclosure;

FIG. 5 shows another illustrative example of a display screen for use in accessing media content in accordance with some embodiments of the disclosure;

FIG. 6 is a block diagram of an illustrative user equipment device in accordance with some embodiments of the disclosure;

FIG. 7 is a block diagram of an illustrative media system in accordance with some embodiments of the disclosure;

FIG. 8 is a flowchart of illustrative steps for modifying speech in a media asset, in accordance with some embodiments of the disclosure;

FIG. 9 is a flowchart of illustrative steps for determining an amount to adjust a first accent type to a second accent type, in accordance with some embodiments of the disclosure;

FIG. 10 is a flowchart of illustrative steps for determining a similarity between a phoneme of a first accent type and a corresponding phoneme of a second accent type, in accordance with some embodiments of the disclosure;

FIG. 11 is a flowchart of illustrative steps for retrieving replacement audio for a phoneme, in accordance with some embodiments of the disclosure; and

FIG. 12 is another flowchart of illustrative steps for modifying speech in a media asset, in accordance with some embodiments of the disclosure.

### DETAILED DESCRIPTION

Systems and methods are described for increasing the language accessibility of media content by modifying accents in speech. For example, a particular character in a media asset may speak in a dialect (e.g., British English) that is difficult for some listeners to understand. The systems and methods, after detecting the dialect of the speech of the particular character, may determine a user preference for an amount to adjust the dialect toward another dialect that the user more easily understands (e.g., American English). For example, specific phonemes and/or words may be modified because they are different between the two dialects, while others may not need to be modified. The systems and methods replace phonemes and/or words determined to need modification with phonemes and/or words that are intermediate between the two dialects. In this way, the systems and methods retain some of the characteristics of the original speech of the character while allowing a user to more easily comprehend the speech.

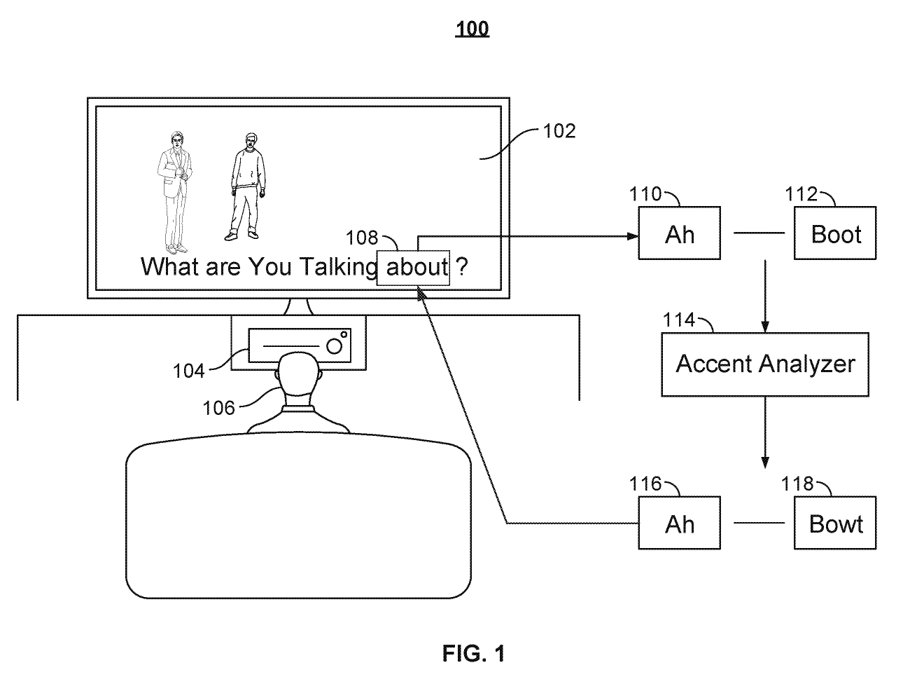

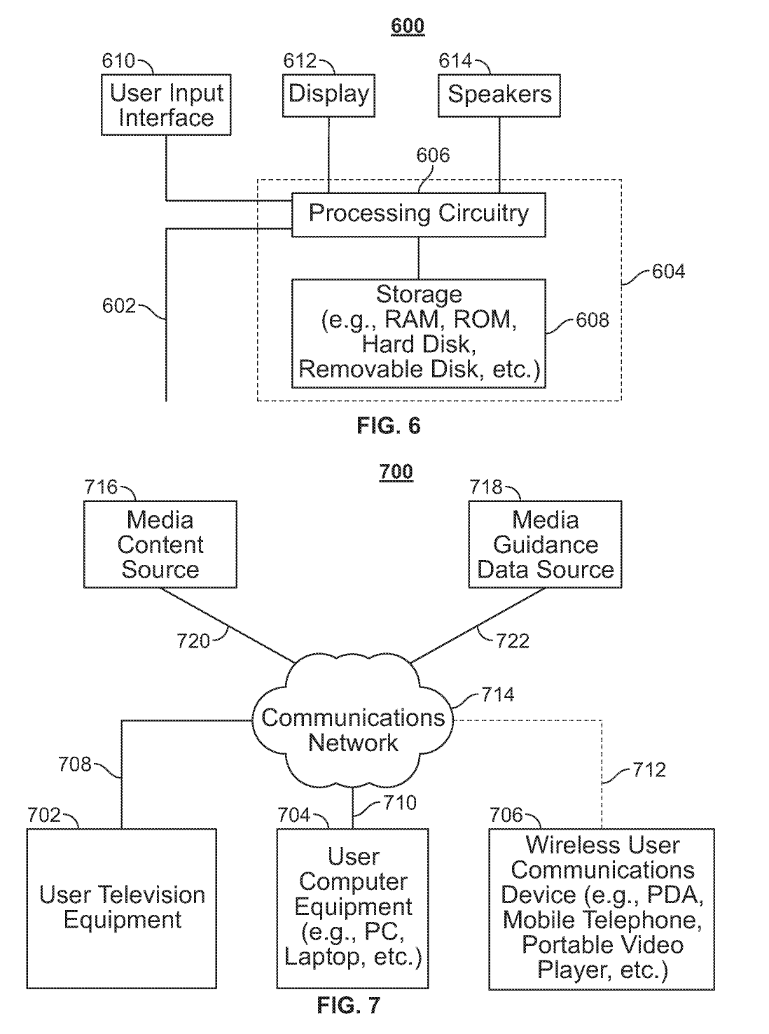

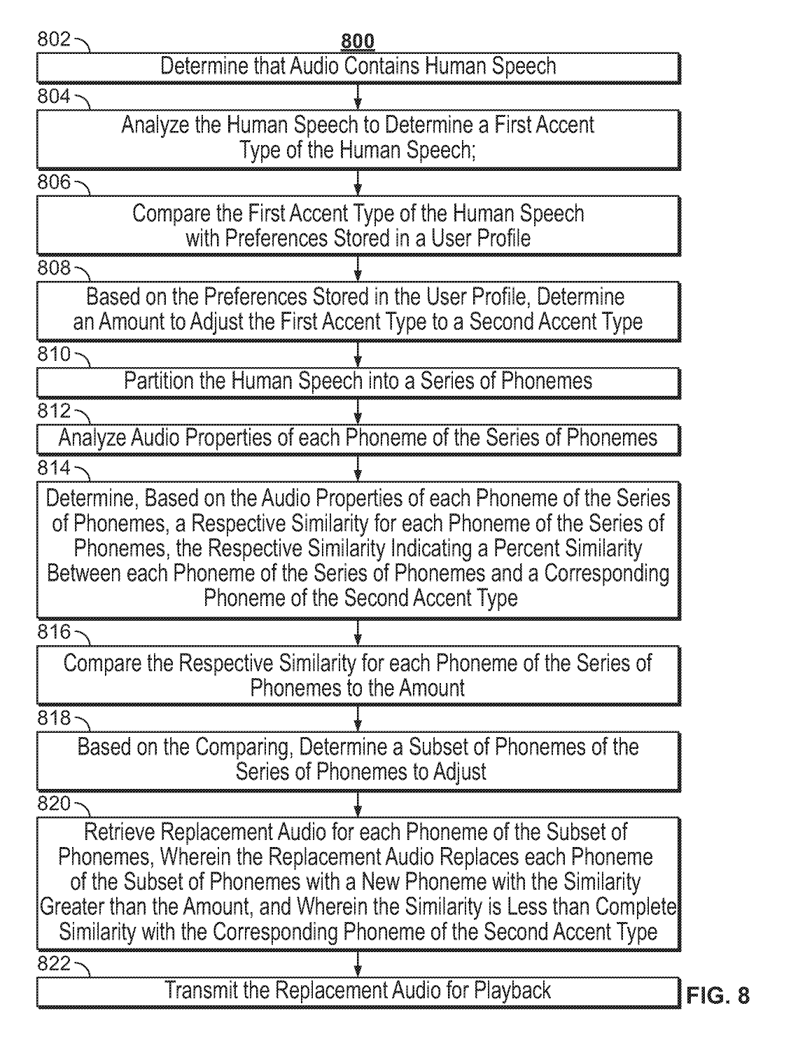

FIG. 1 shows an illustrative example of a system modifying speech in a media asset, in accordance with some embodiments of the disclosure. For example, display 100 may be coupled to user equipment device 104 which executes a media guidance application in order to display media asset 102. Media asset 102 may contain audio with human speech 108. Human speech 108 may include a word in a first accent that may be broken down into phonemes 110 and 112. The media guidance application may utilize accent analysis module 114 to analyze phonemes (e.g., phonemes 110 and 112) and determine whether each phoneme of the human speech needs to be adjusted (e.g., based on preferences of user 106). Specifically, accent analysis module 114 may determine that phoneme 110 does not need to be adjusted and outputs phoneme 116 to user 106. Accent analysis module 114 may determine that phoneme 112 does need to be adjusted to be more similar to a second accent and may output phoneme 118 to user 106 such that user 106 can more easily understand the human speech. Display 100 may appear on one or more user devices (e.g., any of the devices listed in FIGS. 6-7 below). Moreover, the media guidance application may use one or more of the processes described in FIGS. 8-13 to generate display 100 or any of the features described therein.

In some embodiments, the media guidance application may determine that audio contains human speech. For example, the media guidance application may analyze audio characteristics, such as the amplitude and frequency of an audio file (e.g., media asset 102) at given time points and compare with a rule-set for determining whether human speech (e.g., human speech 108) is present at each time point. Specifically, the rule-set may contain particular frequencies that correspond to human speech, audio fingerprints, etc. that can be compared to the audio characteristics of an audio file at a given time. The media guidance application may analyze the audio file of a media asset in real-time, prior to selection by a user, or at any other time. For example, the media guidance application may access a database containing time codes when human speech occurs in a media asset (e.g., the analysis occurs before the user selects the media asset). In this situation, the media guidance application may save computational resources by not having to re-analyze audio that has been analyzed previously (e.g., by a server, or another media guidance application).

The media guidance application may analyze the human speech to determine a first accent type of the human speech. For example, the media guidance application may further analyze a segment of audio (e.g., phonemes 110 and 112) in a media asset (e.g., media asset 102) containing human speech (e.g., human speech 108) to determine a particular accent type of the human speech. For example, the characteristics of a segment in the audio of a media asset containing human speech may be compared to audio fingerprints of a variety of dialects in different languages to determine an accent type of the speaker (e.g., using accent analysis module 114). In some embodiments, the media guidance application may utilize constraints to focus the search on more probable accent types. For example, in a movie in English, the media guidance application may search for only English accent types. Alternatively or additionally, the media guidance application may search through metadata associated with the media asset to determine a probable accent type. For example, a movie about hockey is likely to contain a Canadian accent.

In some embodiments, the media guidance application may access a database containing accent types of human speech that begins at particular time codes to determine the first accent type. Specifically, the media guidance application may retrieve, from the audio (e.g., in media asset 102) containing the human speech (e.g., human speech 108), a time code corresponding to a start time of the human speech. For example, the media guidance application may determine from a first time code that the current progress point in a media asset is thirty minutes from the beginning of the media asset. The time code may be a numerical representation of the number of frames of the media asset presented at a particular point in time. For example, the media guidance application may retrieve the time code (00:30:00:00) corresponding to (hour:minute:second:frame). The media guidance application may determine that at that time code, human speech is occurring based on comparing the time code with a plurality of time codes in a database, or based on analyzing characteristics of the audio at that time code, as described above. The media guidance application may compare the time code to a plurality of time codes stored in a database, wherein each time code of the plurality of time codes stored in the database is associated with an accent type of a plurality of accent types. For example, the database may contain an identifier of what accent and/or language the human speech is. In some embodiments, the database may additionally contain an indication that human speech is present at a particular time code (e.g., a Boolean value). The media guidance application may compare the value for the time code (e.g., 00:30:00:00) with values stored in the database to determine a match.

The media guidance application may determine that the time code matches a first time code stored in the database. For example, the media guidance application may determine that a time code from the audio (e.g., in media asset 102) matches a stored time code in the database. In some embodiments, if the time code is within a threshold (e.g., 1 second) of a time code in the database a match is determined. The media guidance application may then retrieve the first accent type from a field associated with the first time code. For example, the database may be structured as a table where each row contains a field with a time code in the audio and another field containing an identifier of the first accent type (e.g., of human speech 108) being spoken at that time in the audio. As a specific example, the media guidance application may retrieve a value of “Canadian English” as the first accent type being spoken at a particular time. In some embodiments, the database is constructed manually. For example, a user may manually input time codes where human speech occurs in a media asset and an identifier of an accent type of the human speech. In other embodiments, the database may be constructed automatically (e.g., by the media guidance application) based on comparison of detected human speech with candidate accent types. For example, human speech may be detected based on a rule-set, as described above. The human speech may then be analyzed and compared to characteristics of particular accent types. Based on the analysis and comparison, an identifier of an accent type may be assigned to the human speech at a given time code and stored in the database.

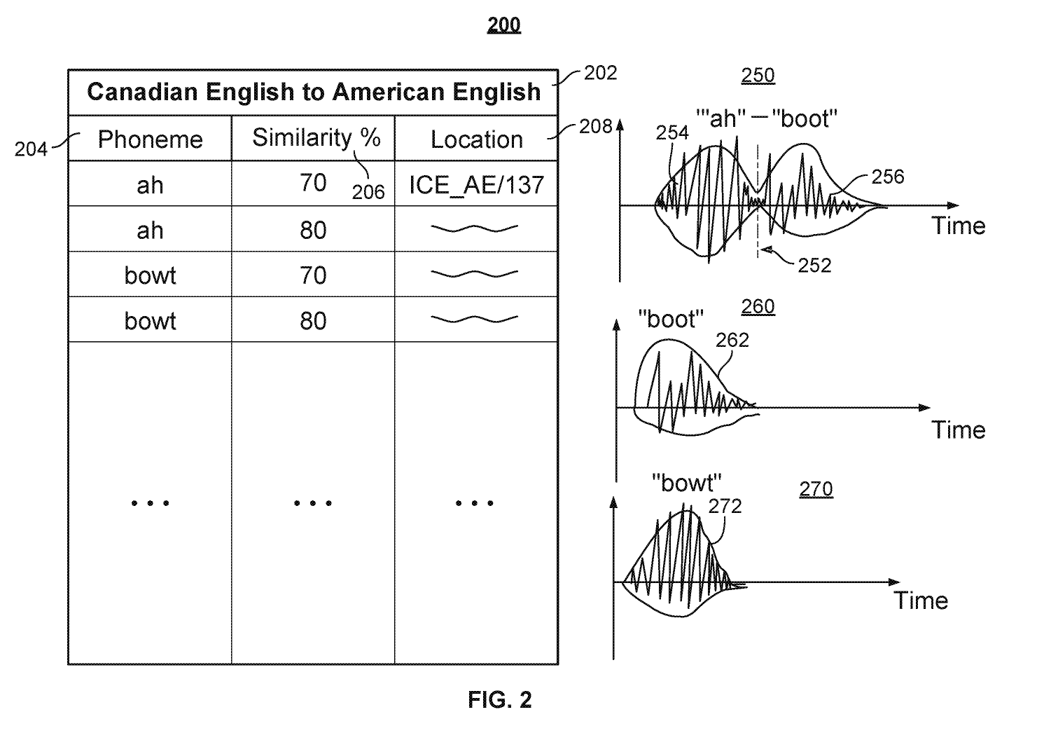

In some embodiments, the media guidance application may determine the first accent type based on comparing a phoneme or subset of phonemes of the audio with corresponding phonemes of different accent types. Specifically, the media guidance application may compare the audio properties of a first phoneme (e.g., phoneme 110) of the series of phonemes with the audio properties of a respective corresponding phoneme of each accent type of a plurality of candidate accent types. For example, the media guidance application may partition the audio (e.g., of media asset 102) into phonemes completely as described below with respect to FIG. 2, or selectively partition one or a few phonemes for the purposes of comparison with corresponding phonemes to determine the first accent type. The media guidance application may determine (e.g., using accent analysis module 114) a corresponding phoneme based on a speech-to-text algorithm and a mapping of the phoneme to a plurality of phonemes of different accent types stored in a database. The media guidance application may then compare the audio properties (e.g., the amplitude and frequency or frequencies present at particular points in time) of the first phoneme with corresponding phonemes of different accent types. The media guidance application may determine, based on comparing the first phoneme with the respective corresponding phoneme of each accent type, a similarity value between the first phoneme and the respective corresponding phoneme of each accent type. For example, the media guidance application may determine that a first phoneme “ah” (e.g., based on the speech-to-text algorithm) is 50% similar based on the audio characteristics to the corresponding phoneme for “ah” in Canadian English, and 90% similar to the corresponding phoneme in British English.

The media guidance application may rank the similarity value between the first phoneme and the respective corresponding phoneme of each accent type. For example, the media guidance application may determine that since 90% similar is greater than 50% similar, the British English accent should be ranked higher than the Canadian English accent. The media guidance application may, based on the ranking, determine the first accent type that corresponds to the human speech (e.g., human speech 108). For example, since the phoneme of British English accent type had a higher ranked similarity to the phoneme (e.g., phoneme 110) in the audio (e.g., of media asset 102), the media guidance application may determine that the first accent in the audio is British English. The media guidance application may compare multiple phonemes (e.g., phonemes 110 and 112) with corresponding phonemes in candidate accent types in order to increase the certainty of the determined first accent type. For example, if the media guidance application determines that four phonemes of the audio correspond to British English as the highest ranked accent type, then the media guidance application may provide a higher confidence rating in the first accent type. The higher confidence rating may be factored by the media guidance application when determining an amount to adjust the audio. In some embodiments, the media guidance application may store an indication that the first accent type of the human speech begins at a specific time (e.g., associated with a time code when it begins) such that the accent type can be more quickly determined in the future (e.g., in a database, as described above).

The media guidance application may compare the first accent type of the human speech with preferences stored in a user profile. For example, the media guidance application may retrieve a user profile associated with a user (e.g., user 106 consuming media asset 102) from storage or a remote server. The media guidance application may then retrieve stored characteristics and preferences of the user and determine whether they relate to the first accent type (e.g., of human speech 108). For example, the media guidance application may determine that the user's native accent type is American English from a user preference, which is different than the detected accent type (e.g., Canadian English). In some embodiments, the media guidance application may access a data structure storing user preferences related to how easily a user understands different accent types (e.g., values ranking on a scale of 1 to 10 how well a user understands different accents). Values stored in the data structure may correspond to the amount to adjust the first accent type, discussed further below.

The media guidance application may, based on the preferences stored in the user profile, determine an amount to adjust the first accent type to a second accent type. For example, the preferences (e.g., associated with user 106) may contain a value or indication of the amount to adjust the first accent type (e.g., of human speech 108) to a second accent type. As a specific example, the media guidance application may retrieve a value of 2 out of 10 that a user can understand a particular accent and based on the value determine an amount to adjust the audio (e.g., to be more like the user's accent type). The media guidance application may determine the amount based on a rule-set. For example, the media guidance application may store average values for how easily users who identify with one accent type can understand the detected accent type in the media asset (e.g., media asset 102). For example, based on a user's geographic location, demographics, or other stored information in their profile, the media guidance application may determine a probable accent type for the user as the second accent type. The media guidance application may then determine the amount based on the probable accent type of the user (e.g., from a data structure containing a plurality of average values for amounts to adjust the audio from one accent type to another). The media guidance application may then adjust the audio from the detected accent type to the probable accent type of the user by the amount (e.g., using accent analysis module 114).

In some embodiments, the media guidance application may determine an amount to adjust the first accent type to the second accent type based on comparing user preferences with a database storing amounts to adjust accent types. Specifically, the media guidance application may retrieve the user profile (e.g., for user 106). For example, the media guidance application may retrieve the user profile from storage or a remote server. The user profile may be specific to a user (e.g., Tom) or a user device (e.g., user equipment device 104). The media guidance application may retrieve, from the user profile, a value indicating that a first preference of the preferences stored in the user profile is for the second accent type. For example, the media guidance application may retrieve the user's geographic location, demographics, or other stored information in their profile, and may determine a probable accent type for the user as the second accent type. The media guidance application may also retrieve an indication of a user's preferred accent type stored in the user profile as the second accent type, e.g., “American English.”

The media guidance application may access a data structure in the user profile containing a plurality of amounts to adjust accent types to the second accent type. For example, the data structure may be organized as a table where each row contains a field with an identifier of the first accent type, another field with an identifier of the second accent type, and another field with a value for the amount to adjust the first accent type to the second accent type. The media guidance application may search the data structure to determine an amount that corresponds to the particular first accent type and second accent type. For example, the media guidance application may retrieve a value of 70 (e.g., representing 70%) from a field associated with fields for a first accent type of Canadian English and a second accent type of American English.

The media guidance application may partition the human speech into a series of phonemes. For example, the media guidance application may subdivide the audio containing human speech into smaller sections such that each section contains a single phoneme of a word (e.g. phonemes 110 and 112). The media guidance application may determine where (e.g., at which time codes) to subdivide the audio (e.g., of media asset 102) based on characteristics of the audio indicating that a phoneme has ended and/or a new phoneme has started. Specifically, the media guidance application may analyze the audio (e.g., frequencies and/or amplitude as a function of time) to determine times that correspond to a change between two phonemes. Based on this analysis, the media guidance application may generate short audio clips for each phoneme spoken in the human speech (e.g., human speech 108), which may then be modified as discussed below with respect to FIG. 2.

The media guidance application may analyze audio properties of each phoneme of the series of phonemes. For example, for each phoneme (e.g., phonemes 110 and 112), the media guidance application may analyze the frequency or frequencies present as a function of time, amplitude as a function of time, total length, envelope, or other properties of the audio. The media guidance application may store these properties (e.g., in storage or at a remote server) in order to compare the properties of each phoneme in the media asset (e.g., containing human speech) of the first accent type (e.g., of human speech 108) to phonemes of the second accent type.

The media guidance application may determine, based on the audio properties of each phoneme of the series of phonemes, a respective similarity for each phoneme of the series of phonemes, the respective similarity indicating a percent similarity between each phoneme of the series of phonemes and a corresponding phoneme of the second accent type. For example, the media guidance application may compare (e.g., using accent analysis module 114) the audio properties of each phoneme (e.g., phonemes 110 and 112) with candidate phonemes of the second accent type and determine which of the candidate phonemes corresponds to each phoneme of the series of phonemes and how similar the two phonemes are. For example, the media guidance application may iteratively retrieve and compare (e.g., via a program script utilizing a for-loop) each phoneme of the series of phonemes with candidate phonemes of the second accent type. The media guidance application may compare the audio properties of each phoneme with each candidate phoneme and calculate a similarity value. For example, if the amplitude of the sound wave for two phonemes varies by less than 5% over the entire length of the phoneme, it may be an indication that the two are closely related and the media guidance application may assign a high similarity value. Similarly, other audio properties may be compared and similarity values assigned based on a rule-set. Alternatively or additionally, the media guidance application may determine a phoneme of the second accent type that corresponds to each phoneme based on executing a speech-to-text algorithm and mapping the determined text of the phoneme to a corresponding phoneme of the second accent type (e.g., based on a data structure), as discussed further below. The media guidance application may store similarity values for each phoneme of the series of phonemes with a corresponding phoneme of the second accent type in a list or other data structure (e.g., stored locally or remote at a server) in order to determine which phonemes to modify.

In some embodiments, the media guidance application may determine the corresponding phoneme of a second accent type based on a textual representation of a phoneme of the series of phonemes. Specifically, the media guidance application may determine a textual representation of each phoneme of the series of phonemes. For example, the media guidance application may execute a speech-to-text algorithm that analyzes the audio characteristics of each phoneme (e.g., phonemes 110 and 112) and determines a textual representation of each phoneme, e.g., “ah.” For example, the speech-to-text algorithm may utilize a Hidden Markov Model, neural network (e.g., a deep feedforward neural network), or other models useful for processing speech (e.g., each phoneme) and determining a textual equivalent. The media guidance application may access an accent database, wherein the accent database contains a first plurality of fields each containing the textual representation of a phoneme of the first accent type, wherein each of the first plurality of fields is associated with a field of a second plurality of fields containing the textual representation of a phoneme of the second accent type. For example, the accent database may be structured as a table with a plurality of fields with identifiers of phonemes of the first accent type, where each field is linked to a field with an identifier of a phoneme for the second accent type. For example, the link may be a pointer to a field with the British English phoneme for “ah” from a field for the American English phoneme for “ah”. The media guidance application may compare the textual representation for a phoneme from the series of phonemes with each phoneme in the accent database for the first accent type (e.g., American English) to determine a match with a stored identifier of a phoneme. The media guidance application may execute a function (e.g., utilizing a for-loop) to iteratively compare each phoneme of the series of phonemes with phonemes in the accent database.

The media guidance application may determine, based on comparing the textual representation of each phoneme of the series of phonemes with the first plurality of fields, a first respective field of the first plurality of fields that matches the textual representation of each phoneme of the series of phonemes. For example, the media guidance application may determine a stored identifier of a phoneme (e.g., phonemes 110 and 112) of the first accent type that matches the textual representation of each phoneme in the series of phonemes. The media guidance application may retrieve the textual representation of the phoneme of the second accent type corresponding to each phoneme of the series of phonemes from a second respective field of the second plurality of fields, wherein each second respective field is associated with a first respective field. For example, the media guidance application may retrieve the identifier of the textual representation of each phoneme from a field associated with the matched field of the first plurality of fields. The media guidance application may then retrieve audio of the corresponding phoneme from another database that matches the identifier of the phoneme retrieved from the field of the second plurality of fields (e.g., the corresponding phoneme of the second accent type). In some embodiments, the respective field of the second plurality of fields may be associated with a link (e.g., a pointer) to a location (e.g., in storage or at a remote server) where audio associated with a phoneme of the second accent type that corresponds to a phoneme of the first accent type is located.

In some embodiments, the media guidance application may determine the similarity between a phoneme of the first accent type and a corresponding phoneme of the second accent type by comparing the frequency and amplitude as functions of time. Specifically, the media guidance application may compare (e.g., using accent analysis module 114) the audio properties of each phoneme (e.g., phonemes 110 and 112) of the series of phonemes with the corresponding phoneme of the second accent type by generating, based on analyzing the audio properties of each phoneme of the series of phonemes, first values for frequency and amplitude as functions of time for each phoneme of the series of phonemes. For example, the media guidance application may generate a data structure (e.g., a list, table, or array) for each phoneme and populate the data structure with particular critical values of the amplitude and frequency at particular times. For example, the media guidance application may store, for audio of each phoneme, inflection points, local and global minima and maxima, values and times when particularly large changes occurred in the amplitude and/or frequency etc. in order to generate a fingerprint of the audio for quicker and easier comparison. The media guidance application may compare the first values for each phoneme of the series of phonemes with second values for the corresponding phoneme of the second accent type. For example, the media guidance application may store (e.g., local in storage or remote at a server) a data structure containing similar information (e.g., the critical values) for each corresponding phoneme of the second accent type. The media guidance application may compare the values (e.g., the critical values stored in the data structures) by retrieving corresponding values (e.g., the maximum slope of amplitude as a function of time for audio of both phonemes) from each data structure and determining a difference between the two values.

The media guidance application may determine a degree to which the first values and the second values correspond. For example, based on the comparison, the media guidance application may determine an average difference between corresponding values of each phoneme (e.g., phonemes 110 and 112) of the series of phonemes of the first accent type (e.g., of human speech 108) with a corresponding phoneme of the second accent type. For example, the average difference may be a sum of the difference between the values, which may be weighted in some embodiments. The media guidance application may then determine the respective similarity for each phoneme of the series of phonemes based on the degree. For example, the media guidance application may assign a similarity to each phoneme of the series of phonemes based on the average difference between the values. In some embodiments, certain critical points may be more indicative of similarity between two phonemes than others and may be weighted more highly when determining the similarity. The similarity may be determined based on comparing the average difference or any other measure determined from the comparison of the values of two phonemes with a data structure containing similarity values (e.g., percentages) associated with particular average differences and/or other values determined based on the comparison.

The media guidance application may then compare the respective similarity for each phoneme of the series of phonemes to the amount. For example, the media guidance application may, based on the amount, determine (e.g., using accent analysis module 114) that phonemes (e.g., phoneme 110) that are above a threshold similarity between the two accent types do not need to be modified, but phonemes that are below the threshold similarity (e.g., phoneme 112) need to be modified such that a newly generated phoneme is above the threshold similarity. The threshold similarity may be determined by the media guidance application based on the amount. For example, a stored user preference indicating that the user understands a certain accent 2 out of 10, with 10 being complete understanding, may correspond to a threshold similarity of 80%. The media guidance application may retrieve a mapping of the amount to threshold similarity from storage or from a remote server. The mapping may be any mathematical function that processes the amount as an input and outputs the threshold similarity. In some embodiments, the amount may be the threshold similarity.

The media guidance application may, based on comparing the respective similarity for each phoneme of the series of phonemes to the amount, determine a subset of phonemes of the series of phonemes to adjust. For example, the media guidance application may access a stored data structure (e.g., in storage or at a remote server) including an identifier of each phoneme (e.g., phonemes 110 and 112) of the series of phonemes and the similarity value for each phoneme of the series of phonemes with the corresponding phoneme of the second accent type. The data structure may also contain an identifier of the corresponding phoneme. The identifiers may be text describing the sound of the phoneme (e.g., “boo”), and/or a pointer to a location where the audio of the phoneme is stored. The media guidance application may iteratively retrieve and compare each similarity value to a threshold value to determine whether to adjust each phoneme, as described above. For each phoneme determined by the media guidance application to need adjusting, the media guidance application may add the identifier to a list or other suitable data structure (e.g., an array or table) containing each phoneme that needs to be adjusted. The media guidance application may also add to the data structure a percentage that each phoneme needs to be adjusted based on the amount. In some embodiments, the media guidance application may adjust phonemes (e.g., using accent analysis module 114) while continuing to determine phonemes that need to be adjusted (e.g., the operations occur in parallel). For example, when a phoneme is determined to need adjustment (e.g., to be more similar to the second accent type so the user can understand the phoneme), that phoneme may be adjusted immediately as opposed to added to a list (e.g., the subset) and adjusted in a batch process after every phoneme that needs adjustment is determined.

The media guidance application may retrieve replacement audio for each phoneme of the subset of phonemes, wherein the replacement audio replaces each phoneme of the subset of phonemes with a new phoneme with the similarity greater than the amount, and wherein the similarity is less than complete similarity with the corresponding phoneme of the second accent type. For example, the media guidance application may generate a new phoneme (e.g., phoneme 118) based on combining a phoneme (e.g., phoneme 112) from the audio (e.g., human speech 108 in media asset 102) and the corresponding phoneme of the second accent type. As a specific example, a Canadian English accent for the word “about” may correspond to the phonemes, “ah” and “boot.” If the second accent type is for American English, then the corresponding phonemes for “about” may be, “ah” and “bowht.” The media guidance application may determine that the first “ah” phonemes are similar (e.g., phoneme 110 does not need to be adjusted and phoneme 116 is output by accent analysis module 114), but that the second needs to be modified (e.g., phoneme 112 does need to be adjusted and phoneme 118 is output by accent analysis module 114). The media guidance application may blend the two phonemes together, by percentages based on the amount (e.g., as described further below with respect to FIG. 2) in order to create a new phoneme (e.g., phoneme 118) that has characteristics of the original phoneme in the audio but is easier for the user to understand. Alternatively or additionally, the media guidance application may retrieve a pre-generated phoneme that contains characteristics of the first and second accent type. For example, the media guidance application may access a database of audio of phonemes, as described further below with respect to FIG. 2. The media guidance application may retrieve a phoneme that is more similar to the second accent type, but still contains characteristics of the first accent type, from the database.

The media guidance application may transmit the replacement audio for playback. For example, upon retrieving replacement audio (e.g., phoneme 118) for each phoneme determined to need adjustment (e.g., phoneme 112) by the media guidance application, the media guidance application may transmit the replacement audio instead of each phoneme that was adjusted. For example, the media guidance application may transmit the audio of the partitioned phonemes (e.g., ordered by time code), but transmit replacement audio instead of the original partitioned phoneme for any phoneme that was adjusted.

In some embodiments, the media guidance application reassembles the audio into a single file prior to transmission for playback. For example, the media guidance application may combine the replacement audio (e.g., phoneme 118) for each phoneme with the original audio for phonemes (e.g., phoneme 116 which may be identical to phoneme 110) that were determined by the media guidance application to not need to be adjusted. The media guidance application may perform pitch-correction, time-scaling, and/or any other audio processing methods to combine replacement audio with the original audio (e.g., original phonemes). For example, the media guidance application may determine a plurality of frequencies present at different time points during a phoneme that has been adjusted and compare the mean, median, and/or mode frequency at each time point or overall with phonemes that correspond to time codes immediately before and after the phoneme. The media guidance application may modulate the pitch (e.g., increase or decrease all or some of the frequencies of the adjusted phoneme such that the mean, media, and/or mode of the neighboring phonemes match or are substantially similar. In this manner, the media guidance application generates an audio track that is customized for the user to better understand an accent type in the audio, while ensuring that the replacement phonemes do not sound unnatural with the original audio (e.g., phonemes that were not adjusted).

FIG. 2 shows two illustrative examples of retrieving replacement audio for a phoneme, in accordance with some embodiments of the disclosure. For example, database 200 may contain table 202 indexing replacement audio between a first and a second accent type (e.g., Canadian English to American English). For example, table 202 may store locations 208 of replacement audio categorized by textual representations of phonemes 204 and similarity values 206. Locations 208 may include pointers to locations in storage where replacement audio that has already been generated to give a particular similarity value between the first and second accent types is stored. Sound wave 250 includes two phonemes, phoneme 254 and 256, which are separated at time 252 based on analyzing the amplitude of sound wave 250 as a function of time. In some embodiments, if a particular similarity value between the first and second accent type does not match any of the entries of table 202, then replacement audio may be generated by combining phoneme 260 of the first accent type with phoneme 270 of the second accent type. In other embodiments, combining phoneme 260 and phoneme 270 is performed without querying table 202 to determine whether replacement audio has already been generated. Phonemes 260 and 270 are a collection of amplitudes as a function of time that form envelopes 262 and 272 respectively, which may be used to more easily determine critical points (e.g., the maximum). Database 200 may be stored locally (e.g., any of the devices listed in FIGS. 6-7 below) or at a remote server. Sound wave 250 and phonemes 260 and 270 may be processed locally (e.g., any of the devices listed in FIGS. 6-7 below) or at a remote server. Moreover, the media guidance application may use one or more of the processes described in FIGS. 8-13 to retrieve the location of replacement audio from database 200 or generate replacement audio from phonemes 260 and 270.

In some embodiments, the media guidance application may partition the audio into shorter segments containing single phonemes based on the amplitude of the audio at particular times. Specifically, the media guidance application may analyze amplitude of the audio (e.g., sound wave 250) that contains the human speech. For example, the media guidance application may determine local minima (e.g., corresponding to a speaker making a new sound corresponding to a new phoneme) that are present in the audio stream. As another example, the media guidance application may analyze when the amplitude changes drastically (e.g., based on the second derivative of the envelope), and/or when it is below a threshold. The threshold may be an absolute amplitude, or may be relative to an earlier value (e.g., 50% less than the most recent local maximum). In some embodiments, the media guidance application may filter the audio to avoid beats and/or other factors that may make determining the amplitude at different times difficult and/or may analyze the envelope of the audio. The media guidance application may determine time codes in the audio where the amplitude is below a threshold amplitude. For example, the media guidance application may generate a data structure (e.g., a list or array) of time codes (e.g., time 252) where the amplitude is below the threshold amplitude for the audio. The media guidance application may determine that between each two successive time codes in the data structure a single phoneme is spoken (e.g., before time 252 phoneme 254 is spoken and after time 252 phoneme 256 is spoken). The media guidance application may extract segments of the audio between consecutive ordered time codes of the determined time codes, wherein each extracted segment includes a phoneme of the series of phonemes. For example, the media guidance application may store audio clips extracted from the audio between the determined time codes in storage (e.g., local or at a remote server).

In some embodiments, the media guidance application may retrieve replacement audio from a database. Specifically, the media guidance application may access a database containing a plurality of replacement audio, wherein each replacement audio of the plurality of replacement audio is associated with a similarity between the first accent type and the second accent type. For example, the media guidance application may access the database (e.g., database 200) in storage or at a remote server (e.g., via a communication network). For example, the database may be a table (e.g., table 202) and may be organized such that each row of the table contains a field for the similarity (e.g., one of similarity values 206) and an associated field with a pointer to a location of the replacement audio (e.g., one of locations 208). As a specific example, the database may contain rows where the similarity between a particular phoneme of the first accent type and a corresponding phoneme of the second accent type of 50%, 60%, 70%, and 80%. In some embodiments, each row additionally contains a textual representation of the phoneme (e.g., textual representations of phonemes 204). In other embodiments, the media guidance application accesses an index data structure that points to specific table for each particular phoneme of the first accent type.

The media guidance application may retrieve, from the database, replacement audio for each phoneme of the subset of phonemes, wherein each replacement audio corresponds to a similarity that is greater than the amount. For example, the media guidance application may determine that a phoneme “ah” in the first accent type has a similarity of 60% with a corresponding phoneme of the second accent type. The media guidance application may further determine that in order to exceed the amount (e.g., so that the user can understand the phoneme) a similarity of 80% is needed. The media guidance application may compare the similarity that is needed for the replacement audio (e.g., 80%) with similarities (e.g., similarity values 206) stored in the database (e.g., table 202) for the particular phoneme (e.g., based on textual representation of phonemes 204). Upon determining a match, the media guidance application may retrieve audio from a location (e.g., based on a corresponding location of locations 208 with the matched entry in table 202) either in local storage or remote at a server. The media guidance application may execute a program script (e.g., utilizing a for-loop) to iteratively retrieve replacement audio that is greater than the amount for each phoneme of the subset.

In some embodiments, the media guidance application may generate a new phoneme by combining audio of a phoneme of the first accent type and a phoneme of the second accent type. Specifically, the media guidance application may retrieve a corresponding phoneme of the second accent type for each phoneme of the subset of phonemes. For example, the media guidance application may retrieve audio of a corresponding phoneme (e.g., phoneme 270) of each phoneme in the subset of phonemes (e.g., phoneme 260). The media guidance application may retrieve the audio from storage or from a remote server. The media guidance application may retrieve the appropriate corresponding audio by searching a plurality of stored audio clips each with an identifier for an audio clip that matches an identifier of each corresponding audio (e.g., “Am_En_ah” for the phoneme “ah” in American English). The media guidance application may align a first audio clip of each phoneme of the subset of phonemes with a second respective audio clip of the corresponding phoneme of the second accent type. For example, because different speakers may have spoken the phoneme in the first accent type and the corresponding phoneme in the second accent type, simply merging the two audio clips (e.g., phonemes 260 and 270) may result in unintelligible audio since the features of the audio waves (e.g., frequencies and amplitudes) that don't line up will interfere. To correct this, the media guidance application may shorten or lengthen one of the audio clips such that they are the same length and also align critical points (e.g., the global maximum of one audio clip may be at 1 second and another may be at 1.5 seconds). The media guidance application may determine critical points based on envelopes (e.g., envelopes 262 and 272) of the sound waves.

The media guidance application may additionally correct for pitch differences between the two audio clips such that the new phoneme that is generated does not sound like two different voices. For example, the media guidance application may determine a plurality of frequencies present at different time points during each phoneme and a corresponding phoneme (e.g., phonemes 260 and 270) and compare the mean, median, and/or mode frequency at each time point or overall with phonemes that correspond to time codes immediately before and after the phoneme. The media guidance application may modulate the pitch (e.g., increase or decrease all or some of the frequencies of the adjusted phoneme such that the mean, media, and/or mode of the phoneme in the first accent type and the corresponding phoneme match or are substantially similar. In this manner, the media guidance application generates an audio track that is customized for the user to better understand an accent type in the audio, while ensuring that the replacement phonemes do not sound unnatural with the original audio (e.g., phonemes that were not adjusted).

The media guidance application may generate the new phoneme replacing each phoneme of the subset by determining, based on the determined respective similarity for each phoneme of the series of phonemes indicating the percent similarity between each phoneme of the series of phonemes and the corresponding phoneme of the second accent type, a mixing value for each phoneme of the subset of phonemes. For example, after aligning the audio clips of the phonemes, the media guidance application may generate a new phoneme that is a composite of the two audio clips (e.g., a composite of phonemes 260 and 270). The weighting (e.g., percentage) of each audio clip that is mixed into the new audio clip may be based on the amount. For example, the media guidance application may determine that the similarity of a particular phoneme of the subset with a corresponding phoneme is very close to being greater than the amount and thus only a small percentage of the audio clip of the corresponding phoneme of the second accent type (e.g., 10%) needs to be added so that the user can understand the audio. However, if the particular phoneme of the subset is far below the amount, then the media guidance application may mix a greater percentage of the audio clip of the corresponding phoneme of the second accent type (e.g., 10% original phoneme of the first accent type, 90% corresponding phoneme of the second accent type). The media guidance application may combine the first audio clip of each phoneme of the subset of phonemes with the second respective audio clip of the corresponding phoneme of the second accent type, wherein the first audio clip is scaled by the mixing value. For example, the media guidance application may merge the two aligned audio clips into a single audio clip. The media guidance application may perform pitch modulation, smoothing, time-scaling, and any other audio processing algorithms to ensure that the audio clips are combined to form a cohesive new audio clip.

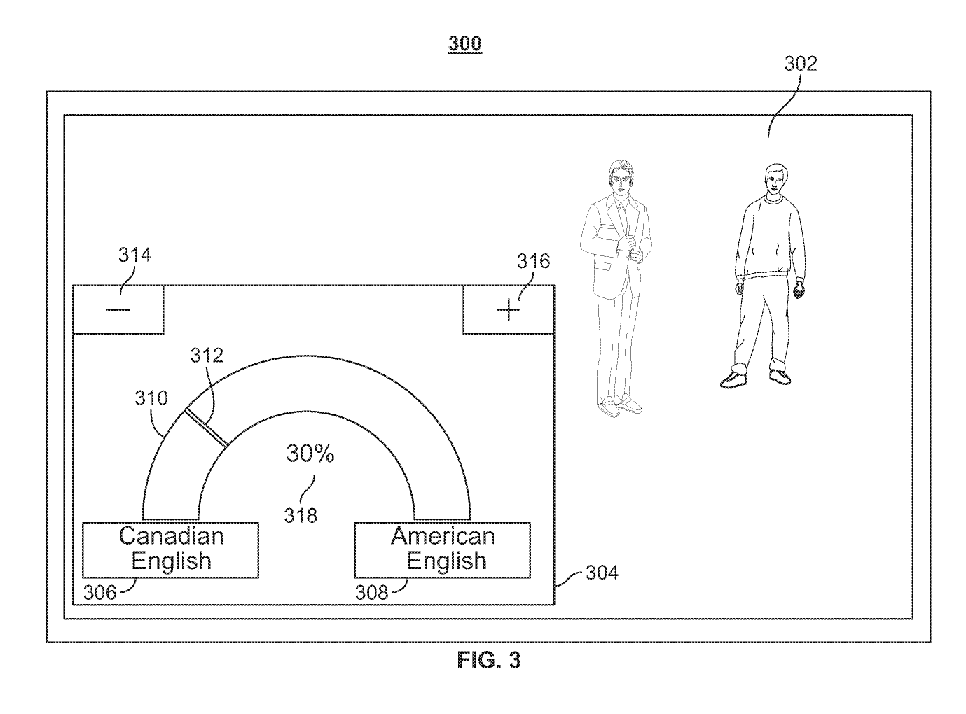

FIG. 3 shows an illustrative example of a display screen including a user interface for adjusting an amount that audio in a media asset is modified, in accordance with some embodiments of the disclosure. For example, display 300 may include media asset 302. Display 300 may also include window 304, which contains dial 310, indicating an amount that first accent 306 is being adjusted toward second accent 308. Dial 310 may contain indicator 312, which visually displays the amount to a user such that the user can see how the two accent types are being blended together (e.g., in order to make media asset 302 easier to understand for the user). Window 304 may additionally include text 318, which displays a numeric value indicating an amount that accent type 306 is being adjusted to accent 308. Additionally, window 304 may contain button 314 to decrease the amount and button 316 to increase the amount. Specifically, selection of buttons 314 or 316 by a user may cause indicator 312 to move to a different position on dial 310 and/or update text 318. Display 300 may appear on one or more user devices (e.g., any of the devices listed in FIGS. 6-7 below). Moreover, the media guidance application may use one or more of the processes described in FIGS. 8-13 to generate display 300 or any of the features described therein.

In some embodiments, the media guidance application may generate an interactive dial for display that indicates the amount the first accent type is being adjusted to the second accent type and allows the user to change the amount. Specifically, the media guidance application may generate for display an interactive dial, wherein the interactive dial indicates the amount to adjust the first accent type to the second accent type. For example, the interactive dial (e.g., dial 310 in window 304) may be shaped as an arc or semicircle where the end points represent audio that is completely of the first accent type (e.g., accent type 306) and audio that is completely of the second accent type (e.g., accent type 308). The dial may contain images (e.g., an image of the character speaking) to inform the user what the dial refers to. The dial may contain an indicator (e.g., indicator 312) that shows the current amount that the audio is being adjusted. The dial may also optionally contain a specific textual indication (e.g., text 318) of the amount (e.g., “30%”). In some embodiments, multiple dials may be generated for display concurrently if multiple characters speaking in different accent types are speaking at similar times. In other embodiments, multiple dials may be generated for display if multiple users are viewing the media asset, including an indication of which user the dial represents. In this embodiment, each user may listen to the audio generated specifically for them using headphones, or the amounts may be averaged and the same audio is transmitted to the users.

The media guidance application may receive a user input to adjust the amount to be more similar to one of the first accent type and the second accent type. For example, the media guidance application may receive a user input (e.g., of button 314 or button 316) using a user input interface (e.g., a remote control) to change the amount. For example, the user may determine that the amount that the speech is currently being adjusted is not sufficient for the user to understand the speech and the user inputs a command to increase the amount toward the second accent type. The media guidance application may, based on receiving the user input, update the amount to adjust the first accent type to the second accent type. For example, the media guidance application may determine additional phonemes in the series of phonemes to adjust based on the updated amount. The media guidance application may also update a position indicator (e.g., indicator 312) of the interactive dial (e.g., dial 310) and/or text describing the amount (e.g., text 318) in response to receiving the user input. In some embodiments, the media guidance application may update a user profile of the user by storing the updated amount for adjusting audio with speech of the first accent type.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

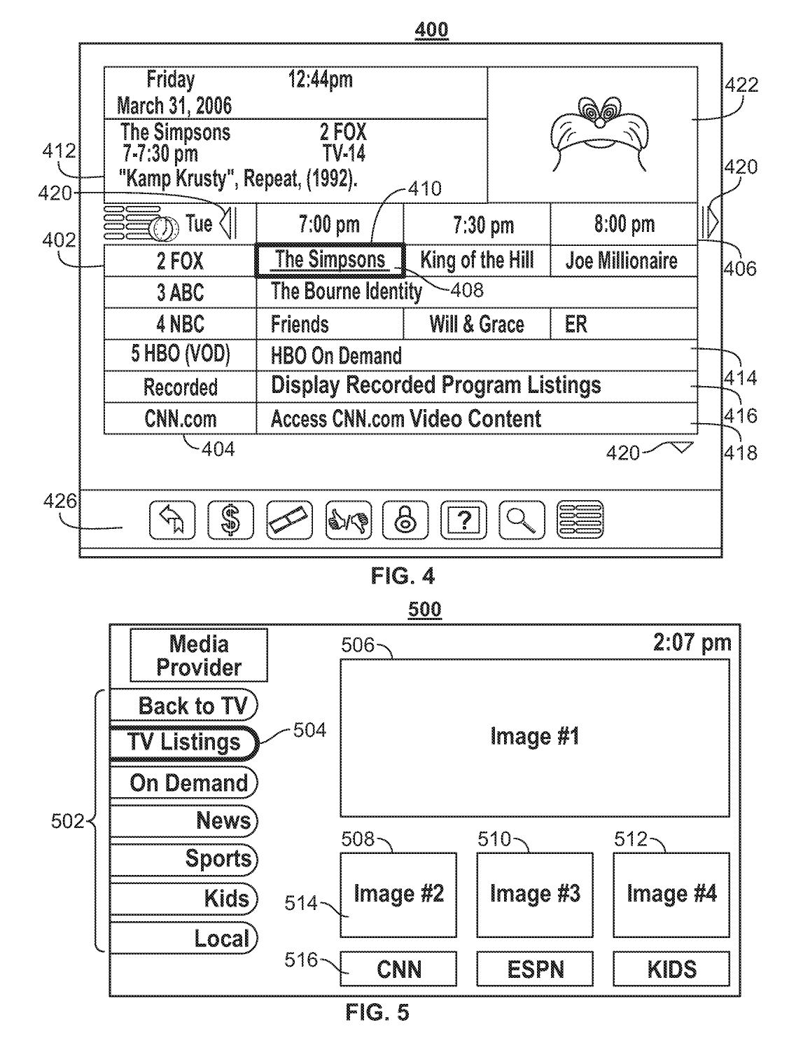

FIGS. 4-5 show illustrative display screens that may be used to provide media guidance data. The display screens shown in FIGS. 4-5 may be implemented on any suitable user equipment device or platform. While the displays of FIGS. 4-5 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 4 shows illustrative grid of a program listings display 400 arranged by time and channel that also enables access to different types of content in a single display. Display 400 may include grid 402 with: (1) a column of channel/content type identifiers 404, where each channel/content type identifier (which is a cell in the column) identifies a different channel or content type available; and (2) a row of time identifiers 406, where each time identifier (which is a cell in the row) identifies a time block of programming. Grid 402 also includes cells of program listings, such as program listing 408, where each listing provides the title of the program provided on the listings associated channel and time. With a user input device, a user can select program listings by moving highlight region 410. Information relating to the program listing selected by highlight region 410 may be provided in program information region 412. Region 412 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 402 may provide media guidance data for non-linear programming including on-demand listing 414, recorded content listing 416, and Internet content listing 418. A display combining media guidance data for content from different types of content sources is sometimes referred to as a “mixed-media” display. Various permutations of the types of media guidance data that may be displayed that are different than display 400 may be based on user selection or guidance application definition (e.g., a display of only recorded and broadcast listings, only on-demand and broadcast listings, etc.). As illustrated, listings 414, 416, and 418 are shown as spanning the entire time block displayed in grid 402 to indicate that selection of these listings may provide access to a display dedicated to on-demand listings, recorded listings, or Internet listings, respectively. In some embodiments, listings for these content types may be included directly in grid 402. Additional media guidance data may be displayed in response to the user selecting one of the navigational icons 420. (Pressing an arrow key on a user input device may affect the display in a similar manner as selecting navigational icons 420.)

Display 400 may also include video region 422, and options region 426. Video region 422 may allow the user to view and/or preview programs that are currently available, will be available, or were available to the user. The content of video region 422 may correspond to, or be independent from, one of the listings displayed in grid 402. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 426 may allow the user to access different types of content, media guidance application displays, and/or media guidance application features. Options region 426 may be part of display 400 (and other display screens described herein), or may be invoked by a user by selecting an on-screen option or pressing a dedicated or assignable button on a user input device. The selectable options within options region 426 may concern features related to program listings in grid 402 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.Tivo.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 7. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 5. Video mosaic display 500 includes selectable options 502 for content information organized based on content type, genre, and/or other organization criteria. In display 500, television listings option 504 is selected, thus providing listings 506, 508, 510, and 512 as broadcast program listings. In display 500 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 508 may include more than one portion, including media portion 514 and text portion 516. Media portion 514 and/or text portion 516 may be selectable to view content in full-screen or to view information related to the content displayed in media portion 514 (e.g., to view listings for the channel that the video is displayed on).

The listings in display 500 are of different sizes (i.e., listing 506 is larger than listings 508, 510, and 512), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. FIG. 6 shows a generalized embodiment of illustrative user equipment device 600. More specific implementations of user equipment devices are discussed below in connection with FIG. 7. User equipment device 600 may receive content and data via input/output (hereinafter “I/O”) path 602. I/O path 602 may provide content (e.g., broadcast programming, on-demand programming, Internet content, content available over a local area network (LAN) or wide area network (WAN), and/or other content) and data to control circuitry 604, which includes processing circuitry 606 and storage 608. Control circuitry 604 may be used to send and receive commands, requests, and other suitable data using I/O path 602. I/O path 602 may connect control circuitry 604 (and specifically processing circuitry 606) to one or more communications paths (described below). I/O functions may be provided by one or more of these communications paths, but are shown as a single path in FIG. 6 to avoid overcomplicating the drawing.

Control circuitry 604 may be based on any suitable processing circuitry such as processing circuitry 606. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions for a media guidance application stored in memory (i.e., storage 608). Specifically, control circuitry 604 may be instructed by the media guidance application to perform the functions discussed above and below. For example, the media guidance application may provide instructions to control circuitry 604 to generate the media guidance displays. In some implementations, any action performed by control circuitry 604 may be based on instructions received from the media guidance application.

In client-server based embodiments, control circuitry 604 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 7). In addition, communications circuitry may include circuitry that enables peer-to-peer communication of user equipment devices, or communication of user equipment devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as media guidance data described above. Nonvolatile memory may also be used (e.g., to launch a boot-up routine and other instructions). Cloud-based storage, described in relation to FIG. 7, may be used to supplement storage 608 or instead of storage 608.

Control circuitry 604 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 604 may also include scaler circuitry for upconverting and downconverting content into the preferred output format of the user equipment 600. Circuitry 604 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment 600, the tuning and encoding circuitry (including multiple tuners) may be associated with storage 608.

A user may send instructions to control circuitry 604 using user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of user equipment device 600. For example, display 612 may be a touchscreen or touch-sensitive display. In such circumstances, user input interface 610 may be integrated with or combined with display 612. Display 612 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 612 may be HDTV-capable. In some embodiments, display 612 may be a 3D display, and the interactive media guidance application and any suitable content may be displayed in 3D. A video card or graphics card may generate the output to the display 612. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 604. The video card may be integrated with the control circuitry 604. Speakers 614 may be provided as integrated with other elements of user equipment device 600 or may be stand-alone units. The audio component of videos and other content displayed on display 612 may be played through speakers 614. In some embodiments, the audio may be distributed to a receiver (not shown), which processes and outputs the audio via speakers 614.

The guidance application may be implemented using any suitable architecture. For example, it may be a stand-alone application wholly-implemented on user equipment device 600. In such an approach, instructions of the application are stored locally (e.g., in storage 608), and data for use by the application is downloaded on a periodic basis (e.g., from an out-of-band feed, from an Internet resource, or using another suitable approach). Control circuitry 604 may retrieve instructions of the application from storage 608 and process the instructions to generate any of the displays discussed herein. Based on the processed instructions, control circuitry 604 may determine what action to perform when input is received from input interface 610. For example, movement of a cursor on a display up/down may be indicated by the processed instructions when input interface 610 indicates that an up/down button was selected.

In some embodiments, the media guidance application is a client-server based application. Data for use by a thick or thin client implemented on user equipment device 600 is retrieved on-demand by issuing requests to a server remote to the user equipment device 600. In one example of a client-server based guidance application, control circuitry 604 runs a web browser that interprets web pages provided by a remote server. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on equipment device 600. This way, the processing of the instructions is performed remotely by the server while the resulting displays are provided locally on equipment device 600. Equipment device 600 may receive inputs from the user via input interface 610 and transmit those inputs to the remote server for processing and generating the corresponding displays. For example, equipment device 600 may transmit a communication to the remote server indicating that an up/down button was selected via input interface 610. The remote server may process instructions in accordance with that input and generate a display of the application corresponding to the input (e.g., a display that moves a cursor up/down). The generated display is then transmitted to equipment device 600 for presentation to the user.

In some embodiments, the media guidance application is downloaded and interpreted or otherwise run by an interpreter or virtual machine (run by control circuitry 604). In some embodiments, the guidance application may be encoded in the ETV Binary Interchange Format (EBIF), received by control circuitry 604 as part of a suitable feed, and interpreted by a user agent running on control circuitry 604. For example, the guidance application may be an EBIF application. In some embodiments, the guidance application may be defined by a series of JAVA-based files that are received and run by a local virtual machine or other suitable middleware executed by control circuitry 604. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 600 of FIG. 6 can be implemented in system 700 of FIG. 7 as user television equipment 702, user computer equipment 704, wireless user communications device 706, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 6 may not be classified solely as user television equipment 702, user computer equipment 704, or a wireless user communications device 706. For example, user television equipment 702 may, like some user computer equipment 704, be Internet-enabled allowing for access to Internet content, while user computer equipment 704 may, like some television equipment 702, include a tuner allowing for access to television programming. The media guidance application may have the same layout on various different types of user equipment or may be tailored to the display capabilities of the user equipment. For example, on user computer equipment 704, the guidance application may be provided as a web site accessed by a web browser. In another example, the guidance application may be scaled down for wireless user communications devices 706.

In system 700, there is typically more than one of each type of user equipment device but only one of each is shown in FIG. 7 to avoid overcomplicating the drawing. In addition, each user may utilize more than one type of user equipment device and also more than one of each type of user equipment device.

In some embodiments, a user equipment device (e.g., user television equipment 702, user computer equipment 704, wireless user communications device 706) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.Tivo.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 714. Namely, user television equipment 702, user computer equipment 704, and wireless user communications device 706 are coupled to communications network 714 via communications paths 708, 710, and 712, respectively. Communications network 714 may be one or more networks including the Internet, a mobile phone network, mobile voice or data network (e.g., a 4G or LTE network), cable network, public switched telephone network, or other types of communications network or combinations of communications networks. Paths 708, 710, and 712 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 712 is drawn with dotted lines to indicate that in the exemplary embodiment shown in FIG. 7 it is a wireless path and paths 708 and 710 are drawn as solid lines to indicate they are wired paths (although these paths may be wireless paths, if desired). Communications with the user equipment devices may be provided by one or more of these communications paths, but are shown as a single path in FIG. 7 to avoid overcomplicating the drawing.

Although communications paths are not drawn between user equipment devices, these devices may communicate directly with each other via communication paths, such as those described above in connection with paths 708, 710, and 712, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 714.

System 700 includes content source 716 and media guidance data source 718 coupled to communications network 714 via communication paths 720 and 722, respectively. Paths 720 and 722 may include any of the communication paths described above in connection with paths 708, 710, and 712. Communications with the content source 716 and media guidance data source 718 may be exchanged over one or more communications paths, but are shown as a single path in FIG. 7 to avoid overcomplicating the drawing. In addition, there may be more than one of each of content source 716 and media guidance data source 718, but only one of each is shown in FIG. 7 to avoid overcomplicating the drawing. (The different types of each of these sources are discussed below.) If desired, content source 716 and media guidance data source 718 may be integrated as one source device. Although communications between sources 716 and 718 with user equipment devices 702, 704, and 706 are shown as through communications network 714, in some embodiments, sources 716 and 718 may communicate directly with user equipment devices 702, 704, and 706 via communication paths (not shown) such as those described above in connection with paths 708, 710, and 712.

Content source 716 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 716 may be the originator of content (e.g., a television broadcaster, a Webcast provider, etc.) or may not be the originator of content (e.g., an on-demand content provider, an Internet provider of content of broadcast programs for downloading, etc.). Content source 716 may include cable sources, satellite providers, on-demand providers, Internet providers, over-the-top content providers, or other providers of content. Content source 716 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 718 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 718 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 718 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 718 may provide user equipment devices 702, 704, and 706 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 608, and executed by control circuitry 604 of a user equipment device 600. In some embodiments, media guidance applications may be client-server applications where only a client application resides on the user equipment device, and server application resides on a remote server. For example, media guidance applications may be implemented partially as a client application on control circuitry 604 of user equipment device 600 and partially on a remote server as a server application (e.g., media guidance data source 718) running on control circuitry of the remote server. When executed by control circuitry of the remote server (such as media guidance data source 718), the media guidance application may instruct the control circuitry to generate the guidance application displays and transmit the generated displays to the user equipment devices. The server application may instruct the control circuitry of the media guidance data source 718 to transmit data for storage on the user equipment. The client application may instruct control circuitry of the receiving user equipment to generate the guidance application displays.

Content and/or media guidance data delivered to user equipment devices 702, 704, and 706 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 700 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 7.

In one approach, user equipment devices may communicate with each other within a home network. User equipment devices can communicate with each other directly via short-range point-to-point communication schemes described above, via indirect paths through a hub or other similar device provided on a home network, or via communications network 714. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 716 to access content. Specifically, within a home, users of user television equipment 702 and user computer equipment 704 may access the media guidance application to navigate among and locate desirable content. Users may also access the media guidance application outside of the home using wireless user communications devices 706 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 714. These cloud resources may include one or more content sources 716 and one or more media guidance data sources 718. In addition or in the alternative, the remote computing sites may include other user equipment devices, such as user television equipment 702, user computer equipment 704, and wireless user communications device 706. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 704 or wireless user communications device 706 having content capture feature. Alternatively, the user can first transfer the content to a user equipment device, such as user computer equipment 704. The user equipment device storing the content uploads the content to the cloud using a data transmission service on communications network 714. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 6.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

FIG. 8 is a flowchart of illustrative steps for modifying speech in a media asset, in accordance with some embodiments of the disclosure. For example, a media guidance application implementing process 800 may be executed by control circuitry 604 (FIG. 6). It should be noted that process 800 or any step thereof could be performed on, or provided by, any of the devices shown in FIGS. 6-7.

Process 800 begins with 802, where the media guidance application determines (e.g., via control circuitry 604 (FIG. 6)) that audio contains human speech. For example, the media guidance application may analyze (e.g., via control circuitry 604 (FIG. 6)) audio characteristics, such as the amplitude and frequency of an audio file at given time points and compare with a rule-set for determining whether human speech is present at each time point. Specifically, the rule-set may contain particularly frequencies that correspond to human speech, audio fingerprints, etc. that can be compared to the audio characteristics of an audio file at a given time. The media guidance application may analyze (e.g., via control circuitry 604 (FIG. 6)) the audio file of a media asset in real-time, prior to selection by a user, or at any other time. For example, the media guidance application may access (e.g., via control circuitry 604 (FIG. 6)) a database (e.g., in storage 608 or at media guidance data source 718 accessible via communications network 714) containing time codes when human speech occurs in a media asset (e.g., the analysis occurs before the user selects the media asset). In this situation, the media guidance application may save computational resources by not having to re-analyze audio that has been analyzed previously (e.g., by a server, or another media guidance application).

Process 800 continues to 804, where the media guidance application analyzes (e.g., via control circuitry 604 (FIG. 6)) the human speech to determine a first accent type of the human speech. For example, the media guidance application may further analyze (e.g., via control circuitry 604 (FIG. 6)) a segment of audio in a media asset containing human speech to determine a particular accent type of the human speech. For example, the characteristics of a segment in the audio of a media asset containing human speech may be compared (e.g., via control circuitry 604 (FIG. 6)) to audio fingerprints of a variety of dialects in different languages to determine an accent type of the speaker. In some embodiments, the media guidance application may utilize constraints to focus the search on more probable accent types. For example, in a movie in English, the media guidance application may search (e.g., via control circuitry 604 (FIG. 6)) for only English accent types. Alternatively or additionally, the media guidance application may search (e.g., via control circuitry 604 (FIG. 6)) through metadata associated with the media asset to determine a probable accent type. For example, a movie about hockey is likely to contain a Canadian accent.

Process 800 continues to 806, where the media guidance application compares (e.g., via control circuitry 604 (FIG. 6)) the first accent type of the human speech with preferences stored in a user profile. For example, the media guidance application may retrieve (e.g., via control circuitry 604 (FIG. 6)) a user profile associated with a user (e.g., consuming a media asset) from storage (e.g., storage 608 (FIG. 6)) or a remote server (e.g., media guidance data source 718 accessible via communications network 714 (FIG. 7)). The media guidance application may then retrieve (e.g., via control circuitry 604 (FIG. 6)) stored characteristics and preferences of the user and determine whether they relate to the first accent type. For example, the media guidance application may determine (e.g., via control circuitry 604 (FIG. 6)) that the user's native accent type is American English from a user preference, which is different than the detected accent type (e.g., Canadian English). In some embodiments, the media guidance application may access (e.g., via control circuitry 604 (FIG. 6)) a data structure storing user preferences related to how easily a user understands different accent types (e.g., values ranking on a scale of 1 to 10 how well a user understands different accents).

Process 800 continues to 808, where the media guidance application, based on the preferences stored in the user profile, determines (e.g., via control circuitry 604 (FIG. 6)) an amount to adjust the first accent type to a second accent type. For example, the preferences may contain a value or indication of the amount to adjust the first accent type to a second accent type. As a specific example, the media guidance application may retrieve (e.g., via control circuitry 604 (FIG. 6)) a value of 2 out of 10 that a user can understand a particular accent and based on the value determine an amount to adjust the audio (e.g., to be more like the user's accent type). The media guidance application may determine (e.g., via control circuitry 604 (FIG. 6)) the amount based on a rule-set. For example, the media guidance application may store (e.g., in storage 608 (FIG. 6)) average values for how easily users who identify with one accent type can understand the detected accent type in the media asset. For example, based on a user's geographic location, demographics, or other stored information in their profile, the media guidance application may determine (e.g., via control circuitry 604 (FIG. 6)) a probable accent type for the user. The media guidance application may then determine (e.g., via control circuitry 604 (FIG. 6)) the amount based on the probable accent type of the user (e.g., from a data structure containing a plurality of average values for amounts to adjust the audio from one accent type to another). The media guidance application may then adjust (e.g., via control circuitry 604 (FIG. 6)) the audio from the detected accent type to the probable accent type of the user by the amount.

Process 800 continues to 810, where the media guidance application partitions (e.g., via control circuitry 604 (FIG. 6)) the human speech into a series of phonemes. For example, the media guidance application may subdivide (e.g., via control circuitry 604 (FIG. 6)) the audio containing human speech into smaller sections such that each section contains a single phoneme of a word. The media guidance application may determine (e.g., via control circuitry 604 (FIG. 6)) where (e.g., at which time codes) to subdivide the audio based on characteristics of the audio indicating that a phoneme has ended and/or a new phoneme has started. Specifically, the media guidance application may analyze (e.g., via control circuitry 604 (FIG. 6)) the audio (e.g., frequencies and/or amplitude as a function of time) to determine times that correspond to a change between two phonemes. Based on this analysis, the media guidance application may generate (e.g., via control circuitry 604 (FIG. 6)) short audio clips for each phoneme spoken in the human speech. The media guidance application may store (e.g., via control circuitry 604 (FIG. 6)) the short audio clips corresponding to each phoneme spoken in the human speech locally (e.g., in storage 608 (FIG. 6)) or remotely (e.g., at media guidance data source 718 accessible via communications network 714 (FIG. 7)).

Process 800 continues to 812, where the media guidance application analyzes (e.g., via control circuitry 604 (FIG. 6)) audio properties of each phoneme of the series of phonemes. For example, for each phoneme, the media guidance application may analyze (e.g., via control circuitry 604 (FIG. 6)) the frequency or frequencies present as a function of time, amplitude as a function of time, total length, envelope, or other properties of the audio. The media guidance application may store (e.g., via control circuitry 604 (FIG. 6)) these properties (e.g., in storage 608 (FIG. 6) or at media guidance data source 718 accessible via communications network 714 (FIG. 7)) in order to compare the properties of each phoneme in the media asset (e.g., containing human speech) of the first accent type to phonemes of the second accent type.

Process 800 continues to 814, where the media guidance application determines (e.g., via control circuitry 604 (FIG. 6)), based on the audio properties of each phoneme of the series of phonemes, a respective similarity for each phoneme of the series of phonemes, the respective similarity indicating a percent similarity between each phoneme of the series of phonemes and a corresponding phoneme of the second accent type. For example, the media guidance application may compare (e.g., via control circuitry 604 (FIG. 6)) the audio properties of each phoneme with candidate phonemes of the second accent type and determine which of the candidate phonemes corresponds to each phoneme of the series of phonemes and how similar the two phonemes are. For example, the media guidance application may iteratively retrieve (e.g., via control circuitry 604 (FIG. 6)) and compare (e.g., via a program script utilizing a for-loop) each phoneme of the series of phonemes with candidate phonemes of the second accent type. The media guidance application may compare (e.g., via control circuitry 604 (FIG. 6)) the audio properties of each phoneme with each candidate phoneme and calculate a similarity value. For example, if the amplitude of the sound wave for two phonemes varies by less than 5% over the entire length of the phoneme, it may be an indication that the two are closely related and the media guidance application may assign (e.g., via control circuitry 604 (FIG. 6)) a high similarity value. Similarly, other audio properties may be compared and similarity values assigned based on a rule-set. The media guidance application may store (e.g., via control circuitry 604 (FIG. 6)) similarity values for each phoneme of the series of phonemes with a corresponding phoneme of the second accent type in a list or other data structure (e.g., in storage 608 (FIG. 6) or at media guidance data source 718 accessible via communications network 714 (FIG. 7)) in order to determine which phonemes to modify.

Process 800 continues to 816, where the media guidance application compares (e.g., via control circuitry 604 (FIG. 6)) the respective similarity for each phoneme of the series of phonemes to the amount. For example, the media guidance application may, based on the amount, determine (e.g., via control circuitry 604 (FIG. 6)) that phonemes that are above a threshold similarity between the two accent types do not need to be modified, but phonemes that are below the threshold similarity need to be modified such that a newly generated phoneme is above the threshold similarity. The threshold similarity may be determined by the media guidance application based on the amount. For example, a stored user preference indicating that the user understands a certain accent 2 out of 10, with 10 being complete understanding, may correspond to a threshold similarity of 80%. The media guidance application may retrieve (e.g., via control circuitry 604 (FIG. 6)) a mapping of the amount to threshold similarity from storage (e.g., storage 608 (FIG. 6) or at media guidance data source 718 accessible via communications network 714 (FIG. 7)). The mapping may be any mathematical function that processes the amount as an input and outputs the threshold similarity. In some embodiments, the amount may be the threshold similarity.

Process 800 continues to 818, where the media guidance application, based on the comparing, determines (e.g., via control circuitry 604 (FIG. 6)) a subset of phonemes of the series of phonemes to adjust. For example, the media guidance application may access (e.g., via control circuitry 604 (FIG. 6)) a stored data structure (e.g., storage 608 (FIG. 6) or at media guidance data source 718 accessible via communications network 714 (FIG. 7)) including an identifier of each phoneme of the series of phonemes and the similarity value for each phoneme of the series of phonemes with the corresponding phoneme of the second accent type. The data structure may also contain an identifier of the corresponding phoneme. The identifiers may be text describing the sound of the phoneme (e.g., “boo”), and/or a pointer to a location where the audio of the phoneme is stored. The media guidance application may iteratively retrieve and compare (e.g., via control circuitry 604 (FIG. 6)) each similarity value to a threshold value to determine whether to adjust each phoneme, as described above. For each phoneme determined by the media guidance application to need adjusting, the media guidance application may add (e.g., via control circuitry 604 (FIG. 6)) the identifier to a list or other suitable data structure (e.g., an array or table) containing each phoneme that needs to be adjusted. The media guidance application may also add (e.g., via control circuitry 604 (FIG. 6)) to the data structure a percentage that each phoneme needs to be adjusted based on the amount.

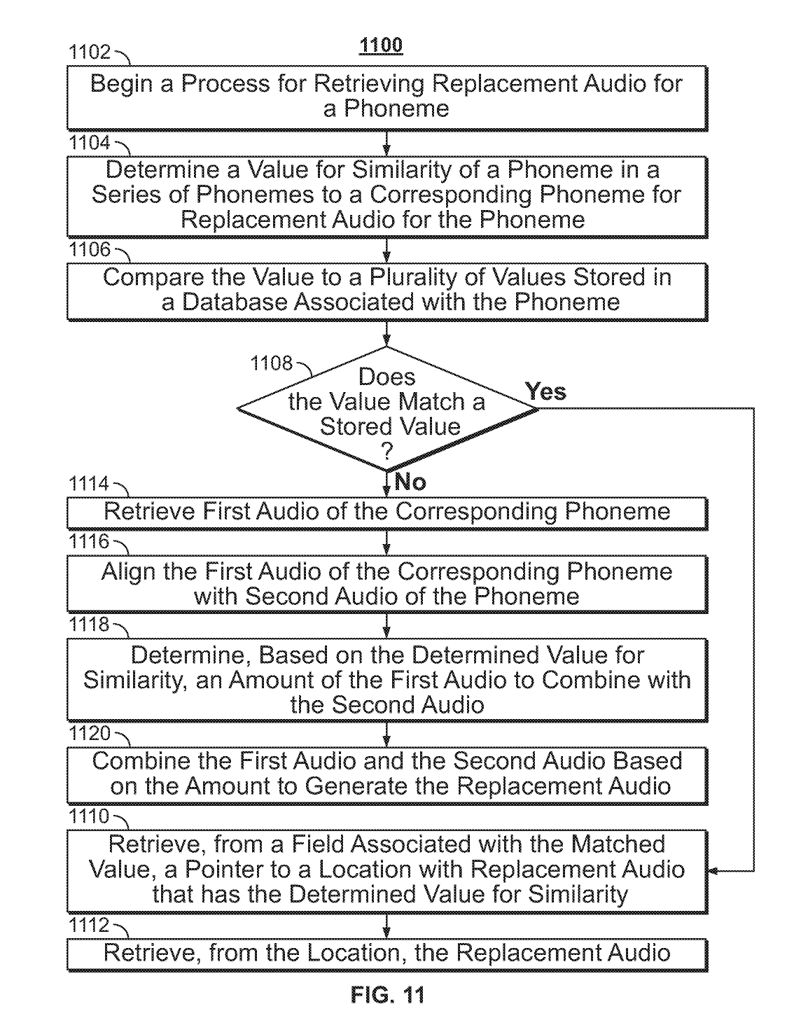

Process 800 continues to 820, where the media guidance application retrieves (e.g., via control circuitry 604 (FIG. 6)) replacement audio for each phoneme of the subset of phonemes, wherein the replacement audio replaces each phoneme of the subset of phonemes with a new phoneme with the similarity greater than the amount, and wherein the similarity is less than complete similarity with the corresponding phoneme of the second accent type. For example, the media guidance application may generate (e.g., via control circuitry 604 (FIG. 6)) a new phoneme based on combining a phoneme from the audio (e.g., in a media asset) and the corresponding phoneme of the second accent type. As a specific example, a Canadian English accent for the word about may correspond to the phonemes, “ah” and “boot.” If the second accent type is for American English, then the phonemes for about may be, “ah” and “bowt.” The media guidance application may determine (e.g., via control circuitry 604 (FIG. 6)) that the first “ah” phonemes are similar, but that the second needs to be modified. The media guidance application may blend (e.g., via control circuitry 604 (FIG. 6)) the two phonemes together, by percentages based on the amount (e.g., as described further below with respect to FIG. 11) in order to create a new phoneme that has characteristics of the original phoneme in the audio but is easier for the user to understand.

Process 800 continues to 822, where the media guidance application transmits (e.g., via control circuitry 604 (FIG. 6)) the replacement audio for playback. For example, upon retrieving replacement audio for each phoneme determined to need adjustment by the media guidance application, the media guidance application may transmit (e.g., via control circuitry 604 (FIG. 6)) the replacement audio instead of each phoneme that was adjusted. For example, the media guidance application may transmit (e.g., via control circuitry 604 (FIG. 6)) the audio of the partitioned phonemes (e.g., ordered by time code), but transmit replacement audio instead of the original partitioned phoneme for any phoneme that was adjusted.

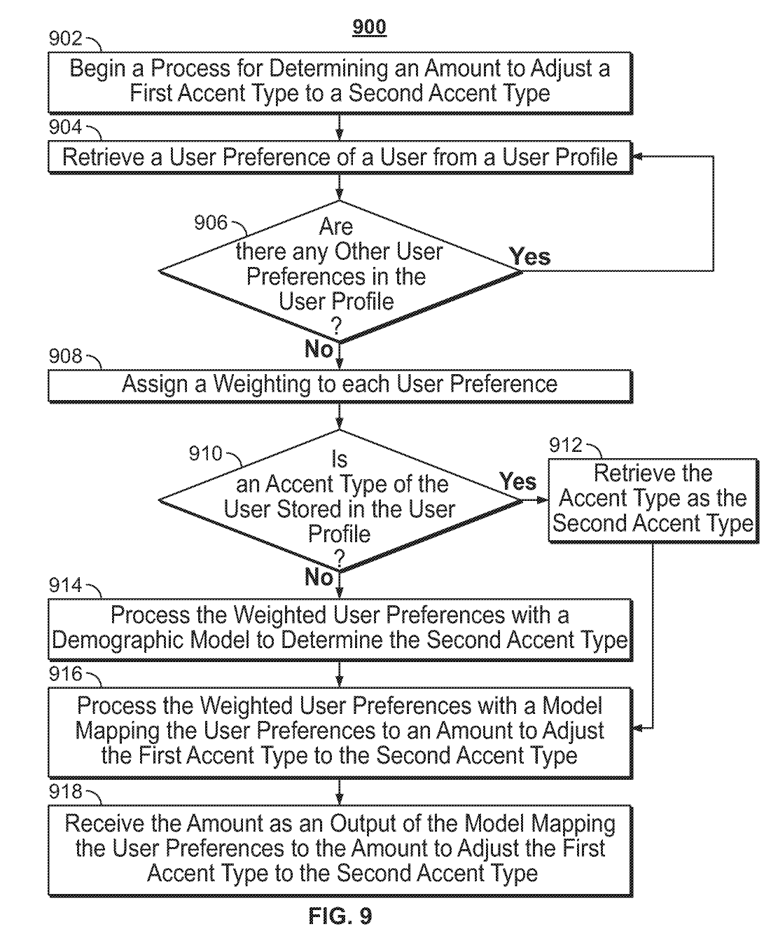

FIG. 9 is a flowchart of illustrative steps for determining an amount to adjust a first accent type to a second accent type, in accordance with some embodiments of the disclosure. For example, a media guidance application implementing process 900 may be executed by control circuitry 604 (FIG. 6). It should be noted that process 900 or any step thereof could be performed on, or provided by, any of the devices shown in FIGS. 6-7. Process 900 starts at 902, where the media guidance application begins (e.g., via control circuitry 604 (FIG. 6)) a process for determining an amount to adjust a first accent type to a second accent type. For example, the media guidance application may initialize the necessary variables and execute (e.g., via control circuitry 604 (FIG. 6)) a program script calling a particular method to execute process 900.

Process 900 continues to 904, where the media guidance application retrieves (e.g., via control circuitry 604 (FIG. 6)) a user preference of a user from a user profile. For example, the media guidance application may retrieve (e.g., via control circuitry 604 (FIG. 6)) a user profile associated with a user (e.g., consuming a media asset) from storage (e.g., storage 608 (FIG. 6)) or a remote server (e.g., media guidance data source 718 (FIG. 7)). The media guidance application may then retrieve (e.g., via control circuitry 604 (FIG. 6)) stored characteristics and preferences of the user. For example, the media guidance application may retrieve (e.g., via control circuitry 604 (FIG. 6)) a preference of the user for British television shows, which may indicate that the user is acclimated to British accents and human speech in a British accent does not need to be adjusted (e.g., if the user's accent is not also British, as discussed further below).

Process 900 continues to 906, where the media guidance application determines (e.g., via control circuitry 604 (FIG. 6)) if there are any other user preferences in the user profile. For example, the media guidance application may execute (e.g., via control circuitry 604 (FIG. 6)) a program script (e.g., utilizing a for-loop) to iteratively retrieve stored user preferences from fields in a data structure of the user profile. The media guidance application may continue to retrieve preferences from the user profile until every stored preference has been retrieved and analyzed. In some embodiments, the media guidance application determines (e.g., via control circuitry 604 (FIG. 6)) whether the user preferences are relevant to the amount to adjust the first accent type to the second accent type. For example, the media guidance application may query for and retrieve (e.g., via control circuitry 604 (FIG. 6)) specific characteristics of the user (e.g., accent types of media assets the user has recently viewed, the user's location, etc.) that are particularly relevant to the model for determining the amount, discussed below. If, at 906, the media guidance application determines that there are other user preferences in the user profile, process 900 returns to 904, where the media guidance application retrieves (e.g., via control circuitry 604 (FIG. 6)) another user preference of the user from the user profile. For example, the media guidance application may retrieve (e.g., via control circuitry 604 (FIG. 6)) another user preference from the user profile, as discussed above, and analyze the value to determine whether it is relevant to a calculation of the amount to adjust the first accent type to the second accent type.

If, at 906, the media guidance application determines that there are not any other user preferences in the user profile, process 900 continues to 908, where the media guidance application assigns (e.g., via control circuitry 604 (FIG. 6)) a weighting to each user preference. For example, the media guidance application may store (e.g., in storage 608 (FIG. 6)) a list or other data structure of each user preference retrieved from the user profile that is relevant to the amount to adjust audio of a first accent type to a second accent type as the user preferences are retrieved (e.g., in step 904). The media guidance application may, for each user preference stored on the list or in the data structure, determine (e.g., via control circuitry 604 (FIG. 6)) a type of the user preference. For example, a user preference for a particular type of media asset (e.g., Russian movies) may be particularly important in determining an amount to adjust accent types, while a user preference for action movies, while possibly somewhat relevant, may not be as relevant. The media guidance application may accordingly assign (e.g., via control circuitry 604 (FIG. 6)) weightings to the user preferences, which can be used by the models described further below. The weightings may be adjusted (e.g., via control circuitry 604 (FIG. 6)) for the same user preferences over time. For example, if a user has viewed one Russian movie, the weighting may not be as large as at a later time when the same user has viewed 100 Russian movies.

Process 900 continues to 910, where the media guidance application determines (e.g., via control circuitry 604 (FIG. 6)) if there is an accent type of the user stored in the user profile. For example, the media guidance application may determine (e.g., via control circuitry 604 (FIG. 6)) whether a field in the user profile contains an identifier (e.g., “American English”) that is associated with the accent type of the user. If, at 910, the media guidance application determines that there is an accent type of the user stored in the user profile, process 900 continues to 912, where the media guidance application retrieves (e.g., via control circuitry 604 (FIG. 6)) the accent type as the second accent type. For example, the media guidance application may determine (e.g., via control circuitry 604 (FIG. 6)) that the accent type of the user retrieved from the profile is an accent type that the user can easily understand. Thus, the media guidance application may assign (e.g., via control circuitry 604 (FIG. 6)) the stored accent type as the second accent type to adjust the first accent type towards such that the user can more easily understand the human speech in the media asset of the first accent type. Process 900 then proceeds to 916, describe further below.

If, at 910, the media guidance application determines that there is not an accent type of the user stored in the user profile, process 900 continues to 914, where the media guidance application processes (e.g., via control circuitry 604 (FIG. 6)) the weighted user preferences with a demographic model to determine the second accent type. For example, if an explicit user preference for a second accent type is not stored, the media guidance application may determine (e.g., via control circuitry 604 (FIG. 6)) a probable accent type that the user can easily understand based on the retrieved user preferences. For example, the media guidance application may convert (e.g., via control circuitry 604 (FIG. 6)) the weighted user preferences into values that can be input to a mathematical model that outputs the most probable accent type the user can understand. For example, based on the location of the user, media assets they have viewed, and other user preferences in the user profile, the model may output a probable accent type of the user (e.g., “American English”).

Process 900 continues to 916, where the media guidance application processes (e.g., via control circuitry 604 (FIG. 6)) the weighted user preferences with a model mapping the user preferences to an amount to adjust the first accent type to the second accent type. For example, upon determining (e.g., via control circuitry 604 (FIG. 6)) the second accent type (e.g., that the user more easily understands), the media guidance application may process the weighted user preferences and the second accent type with another model to determine an amount to adjust the audio of the media asset. Specifically, the model may determine (e.g., via control circuitry 604 (FIG. 6)) how similar the first accent type of the human speech in a media asset is to the second accent type (e.g., that the user more easily understands). For example, the media guidance application may utilize (e.g., via control circuitry 604 (FIG. 6)) a table of mappings between two accent types to determine how similar they are (e.g., American English is 90% similar to British English) and determine a default amount to adjust based on how similar the accent types are (e.g., British English may not need to be adjusted by a large amount because it is similar to American English). The model may modify (e.g., via control circuitry 604 (FIG. 6)) the amount based on user preferences (e.g., if a user always uses subtitles when playing British media assets, it is likely the user has a harder time understanding the speech in a British media asset than an average American English speaker and the amount may need to be adjusted by the media guidance application).

Process 900 continues to 918, where the media guidance application receives (e.g., via control circuitry 604 (FIG. 6)) the amount as an output of the model mapping the user preferences to the amount to adjust the first accent type to the second accent type. For example, the media guidance application may receive (e.g., via control circuitry 604 (FIG. 6)) an output of a value from the model, which may be the amount to adjust the first accent type to the second accent type, or may be mapped (e.g., based on comparison with a lookup table) to the amount.

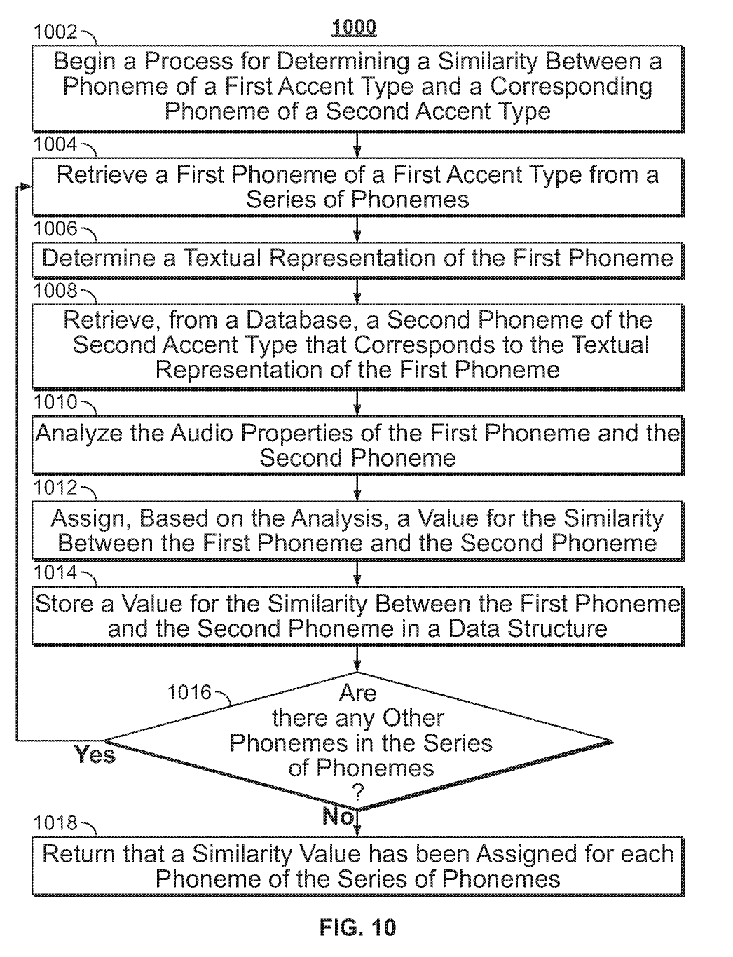

FIG. 10 is a flowchart of illustrative steps for determining a similarity between a phoneme of a first accent type and a corresponding phoneme of a second accent type, in accordance with some embodiments of the disclosure. For example, a media guidance application implementing process 1000 may be executed by control circuitry 604 (FIG. 6). It should be noted that process 1000 or any step thereof could be performed on, or provided by, any of the devices shown in FIGS. 6-7. Process 1000 starts at 1002, where the media guidance application begins (e.g., via control circuitry 604 (FIG. 6)) a process for determining a similarity between a phoneme of a first accent type and a corresponding phoneme of a second accent type. For example, the media guidance application may initialize the necessary variables and execute (e.g., via control circuitry 604 (FIG. 6)) a program script calling a particular method to execute process 1000.

Process 1000 continues to 1004, where the media guidance application retrieves (e.g., via control circuitry 604 (FIG. 6)) a first phoneme of a first accent type from a series of phonemes. For example, the media guidance application may partition (e.g., via control circuitry 604 (FIG. 6)) human speech of a first accent type in a media asset into separate sound clips, each with a single phoneme, as described above with respect to FIG. 8. The media guidance application may retrieve (e.g., via control circuitry 604 (FIG. 6)) the separate sound clips from storage, either locally (e.g., in storage 608 (FIG. 6)) or remotely (e.g., at media guidance data source 718 (FIG. 7)).

Process 1000 continues to 1006, where the media guidance application determines (e.g., via control circuitry 604 (FIG. 6)) a textual representation of the first phoneme. For example, the media guidance application may execute (e.g., via control circuitry 604 (FIG. 6)) a speech-to-text algorithm that analyzes the audio characteristics of each phoneme and determines a textual representation of each phoneme, e.g., “ah.” For example, the speech-to-text algorithm may utilize a Hidden Markov Model, neural network (e.g., a deep feedforward neural network), or other models useful for processing speech (e.g., each phoneme) and determining a textual equivalent.

Process 1000 continues to 1008, where the media guidance application retrieves (e.g., via control circuitry 604 (FIG. 6)), from a database, a second phoneme of the second accent type that corresponds to the textual representation of the first phoneme. For example, the database may be structured as a table with a plurality of fields with identifiers (e.g., textual representations) of phonemes of the first accent type, where each field is linked to a location in memory with audio of a corresponding phoneme of the second accent type. For example, the link may be a pointer to a location in memory storing the British English phoneme for “ah” from a field for the American English phoneme for “ah”. The media guidance application may then retrieve (e.g., via control circuitry 604 (FIG. 6)) the audio from the location. The media guidance application may compare (e.g., via control circuitry 604 (FIG. 6)) the textual representation for a phoneme from the series of phonemes with each phoneme in the accent database for the first accent type (e.g., American English) to determine a match with a stored identifier of a phoneme.

Process 1000 continues to 1010, where the media guidance application analyzes (e.g., via control circuitry 604 (FIG. 6)) the audio properties of the first phoneme and the second phoneme. For example, the media guidance application may generate (e.g., via control circuitry 604 (FIG. 6)) a data structure (e.g., a list, table, or array) for each phoneme and populate the data structure with particular critical values of the amplitude and frequency at particular times. For example, the media guidance application may store (e.g., via control circuitry 604 (FIG. 6)), for audio of each phoneme, inflection points, local and global minima and maxima, values and times when particularly large changes occurred in the amplitude and/or frequency etc. in order to generate a fingerprint of the audio for quicker and easier comparison. The media guidance application may compare (e.g., via control circuitry 604 (FIG. 6)) the first values for each phoneme of the series of phonemes with second values for the corresponding phoneme of the second accent type. For example, the media guidance application may store (e.g., via control circuitry 604 (FIG. 6)) a data structure containing similar information (e.g., the critical values) for each corresponding phoneme of the second accent type. The media guidance application may compare the values (e.g., the critical values stored in the data structures) by retrieving (e.g., via control circuitry 604 (FIG. 6)) corresponding values (e.g., the maximum slope of amplitude as a function of time for audio of both phonemes) from each data structure and determining a difference between the two values.

Process 1000 continues to 1012, where the media guidance application assigns (e.g., via control circuitry 604 (FIG. 6)), based on the analysis, a value for the similarity between the first phoneme and the second phoneme. For example, based on the comparison, the media guidance application may determine (e.g., via control circuitry 604 (FIG. 6)) an average difference between corresponding values of each phoneme of the series of phonemes of the first accent type with a corresponding phoneme of the second accent type. For example, the average difference may be a sum of the difference between the values, which may be weighted in some embodiments. The media guidance application may then determine (e.g., via control circuitry 604 (FIG. 6)) the respective similarity between the first and second phonemes based on the degree. For example, the media guidance application may assign (e.g., via control circuitry 604 (FIG. 6)) a value between the first and second phonemes based on the similarity. For example, if the two phonemes are very similar in average frequency and amplitude as a function of time, the media guidance application may assign (e.g., via control circuitry 604 (FIG. 6)) a large value, such as 99 (e.g., corresponding to a 99% match) between the two phonemes.

Process 1000 continues to 1014, where the media guidance application stores (e.g., via control circuitry 604 (FIG. 6)) a value for the similarity between the first phoneme and the second phoneme in a data structure. For example, the media guidance application may generate (e.g., via control circuitry 604 (FIG. 6)) a data structure with identifiers of each phoneme of the series of phonemes (e.g., a time code where it was detected, the textual representation of the phoneme, etc.) and write a value in a field associated with each phoneme with the value for the similarity between the phoneme and the corresponding phoneme of the second accent type.

Process 1000 continues to 1016, where the media guidance application determines (e.g., via control circuitry 604 (FIG. 6)) if there are any other phonemes in the series of phonemes. For example, the media guidance application may execute a program script utilizing a for-loop to determine a similarity for each phoneme of the series of phonemes (e.g., iterate through identifiers of each phoneme in a data structure and assign a similarity value for each phoneme with a corresponding phoneme of the second accent type). If, at 1016, the media guidance application determines that there are other phonemes in the series of phonemes, process 1000 returns to 1004, where the media guidance application retrieves (e.g., via control circuitry 604 (FIG. 6)) another phoneme of the first accent type from the series of phonemes. For example, the media guidance application continues performing (e.g., via control circuitry 604 (FIG. 6)) the steps of process 1000 for each phoneme of the human speech in the media asset to determine how similar the phoneme is to a corresponding phoneme of a second accent type (e.g., to determine whether each phoneme needs to be adjusted, as described in FIGS. 1 and 8).

If, at 1016, the media guidance application determines that there are not any other phonemes in the series of phonemes, process 1000 continues to 1018, where the media guidance application returns (e.g., via control circuitry 604 (FIG. 6)) that a similarity value has been assigned for each phoneme of the series of phonemes. For example, when the media guidance application determines (e.g., via control circuitry 604 (FIG. 6)) that every field with an identifier of a phoneme in the data structure has a stored associated value in another field, the media guidance application may terminate process 1000 since every phoneme has been assigned a similarity value.

FIG. 11 is a flowchart of illustrative steps for retrieving replacement audio for a phoneme, in accordance with some embodiments of the disclosure. For example, a media guidance application implementing process 1100 may be executed by control circuitry 604 (FIG. 6). It should be noted that process 1100 or any step thereof could be performed on, or provided by, any of the devices shown in FIGS. 6-7. Process 1100 starts at 1102, where the media guidance application begins (e.g., via control circuitry 604 (FIG. 6)) a process for retrieving replacement audio for a phoneme. For example, the media guidance application may initialize the necessary variables and execute (e.g., via control circuitry 604 (FIG. 6)) a program script calling a particular method to execute process 1100.

Process 1100 continues to 1104, where the media guidance application determines (e.g., via control circuitry 604 (FIG. 6)) a value for similarity of a phoneme in a series of phonemes to a corresponding phoneme for replacement audio for the phoneme. For example, the media guidance application may determine (e.g., via control circuitry 604 (FIG. 6)) that the similarity value for a particular phoneme and a corresponding phoneme of the second accent type is below a threshold similarity (e.g., 80%). The media guidance application may then determine (e.g., via control circuitry 604 (FIG. 6)) that the replacement audio needs a replacement value greater than or equal to the threshold similarity (e.g., 80%) and may query a database to determine if replacement audio with that similarity value is available.

Process 1100 continues to 1106, where the media guidance application compares (e.g., via control circuitry 604 (FIG. 6)) the value to a plurality of values stored in a database associated with the phoneme. For example, the media guidance application may access the database in storage (e.g., storage 608 (FIG. 6)) or at a remote server (e.g., media guidance data source (FIG. 7)). For example, the database may be a table and may be organized such that each row of the table contains a field for the similarity and an associated field with a pointer to a location of the replacement audio. As a specific example, the database may contain rows where the similarity between a particular phoneme of the first accent type and a corresponding phoneme of the second accent type of 50%, 60%, 70%, and 80%. In some embodiments, each row additionally contains a textual representation of the phoneme. The media guidance application may compare (e.g., via control circuitry 604 (FIG. 6)) the value needed for the replacement audio with the values in the table to determine if replacement audio is available such that the replacement audio is greater than the threshold similarity.

Process 1100 continues to 1108, where the media guidance application determines (e.g., via control circuitry 604 (FIG. 6)) if the value matches a stored value. For example, the media guidance application may execute a program script (e.g., utilizing a for-loop) to iteratively compare the desired similarity value (e.g., 80%) with the values stored in the data structure. If, at 1108, the media guidance application determines that the value matches a stored value, process 1100 continues to 1110, where the media guidance application retrieves (e.g., via control circuitry 604 (FIG. 6)), from a field associated with the matched value, a pointer to a location with replacement audio that has the determined value for similarity. For example, upon determining a match, the media guidance application may retrieve (e.g., via control circuitry 604 (FIG. 6)) a pointer in a field associated with the similarity that is matched to a location storing replacement audio that fulfills the similarity needed based on the amount.

Process 1100 continues to 1112, where the media guidance application retrieves (e.g., via control circuitry 604 (FIG. 6)), from the location, the replacement audio. For example, the media guidance application may retrieve (e.g., via control circuitry 604 (FIG. 6)) audio from a location (e.g., by accessing the location in memory identified by a pointer in a field associated with the similarity that is matched) either in local storage (e.g., storage 608 (FIG. 6) or remote at a server (e.g., media guidance data source 718 (FIG. 7)).

If, at 1108, the media guidance application determines that the value does not match a stored value, process 1100 continues to 1114, where the media guidance application retrieves (e.g., via control circuitry 604 (FIG. 6)) first audio of the corresponding phoneme. For example, the media guidance application may retrieve (e.g., via control circuitry 604 (FIG. 6)) audio of a corresponding phoneme of each phoneme in the subset of phonemes. The media guidance application may retrieve the audio (e.g., via control circuitry 604 (FIG. 6)) from storage (e.g., via storage 608 (FIG. 6)) or from a remote server (e.g., media guidance data source 718 (FIG. 7)). The media guidance application may retrieve (e.g., via control circuitry 604 (FIG. 6)) the appropriate corresponding audio by searching a plurality of stored audio clips each with an identifier for an audio clip that matches an identifier of each corresponding audio (e.g., “Am_En_ah” for the phoneme “ah” in American English).

Process 1100 continues to 1116, where the media guidance application aligns (e.g., via control circuitry 604 (FIG. 6)) the first audio of the corresponding phoneme with second audio of the phoneme. For example, because different speakers may have spoken the phoneme in the first accent type and the corresponding phoneme in the second accent type, simply merging the two audio clips may result in unintelligible audio since the features of the audio waves (e.g., frequencies and amplitudes) don't line up and will interfere. To correct this, the media guidance application may shorten (e.g., via control circuitry 604 (FIG. 6)) or lengthen one of the audio clips such that they are the same length and also align critical points (e.g., the global maximum of one audio clip may be at 1 second and another may be at 1.5 seconds).

Process 1100 continues to 1118, where the media guidance application determines (e.g., via control circuitry 604 (FIG. 6)), based on the determined value for similarity, an amount of the first audio to combine with the second audio. For example, the weighting (e.g., percentage) of each audio clip that is mixed into the new audio clip may be based on the similarity. For example, the media guidance application may determine (e.g., via control circuitry 604 (FIG. 6)) that the similarity of a particular phoneme of the subset with a corresponding phoneme is very close to being greater than the amount (e.g., desired similarity) and thus only a small percentage of the audio clip of the corresponding phoneme of the second accent type (e.g., 10%) needs to be added so that the user can understand the audio. However, if the particular phoneme of the subset is far below the amount, then the media guidance application may mix (e.g., via control circuitry 604 (FIG. 6)) a greater percentage of the audio clip of the corresponding phoneme of the second accent type (e.g., 10% original phoneme of the first accent type, 90% corresponding phoneme of the second accent type).

Process 1100 continues to 1120, where the media guidance application combines (e.g., via control circuitry 604 (FIG. 6)) the first audio and the second audio based on the amount to generate the replacement audio. For example, the media guidance application may merge (e.g., via control circuitry 604 (FIG. 6)) the two aligned audio clips into a single audio clip. The media guidance application may perform (e.g., via control circuitry 604 (FIG. 6)) pitch modulation, smoothing, time-scaling, and any other audio processing algorithms to ensure that the audio clips are combined to form a cohesive new audio clip.

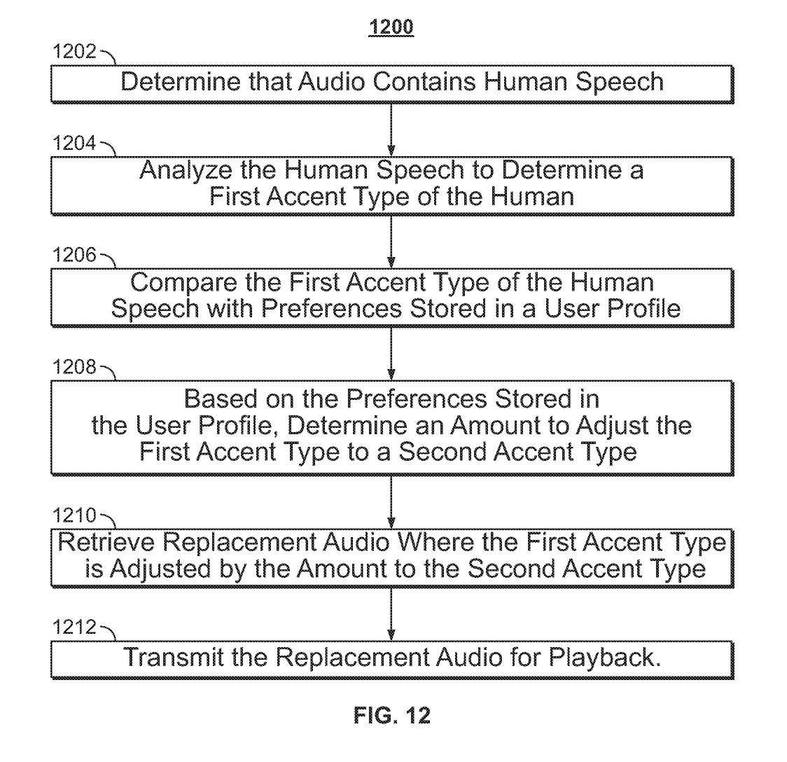

FIG. 12 is another flowchart of illustrative steps for modifying speech in a media asset, in accordance with some embodiments of the disclosure. For example, a media guidance application implementing process 1200 may be executed by control circuitry 604 (FIG. 6). It should be noted that process 1200 or any step thereof could be performed on, or provided by, any of the devices shown in FIGS. 6-7.

Process 1200 begins with 1202, where the media guidance application determines (e.g., via control circuitry 604 (FIG. 6)) that audio contains human speech. For example, the media guidance application may analyze (e.g., via control circuitry 604 (FIG. 6)) audio characteristics, such as the amplitude and frequency of an audio file at given time points and compare with a rule-set for determining whether human speech is present at each time point. Specifically, the rule-set may contain particularly frequencies that correspond to human speech, audio fingerprints, etc. that can be compared to the audio characteristics of an audio file at a given time. The media guidance application may analyze (e.g., via control circuitry 604 (FIG. 6)) the audio file of a media asset in real-time, prior to selection by a user, or at any other time. For example, the media guidance application may access (e.g., via control circuitry 604 (FIG. 6)) a database (e.g., in storage 608 or at media guidance data source 718 accessible via communications network 714) containing time codes when human speech occurs in a media asset (e.g., the analysis occurs before the user selects the media asset). In this situation, the media guidance application may save computational resources by not having to re-analyze audio that has been analyzed previously (e.g., by a server, or another media guidance application).

Process 1200 continues to 1204, where the media guidance application analyzes (e.g., via control circuitry 604 (FIG. 6)) the human speech to determine a first accent type of the human speech. For example, the media guidance application may further analyze (e.g., via control circuitry 604 (FIG. 6)) a segment of audio in a media asset containing human speech to determine a particular accent type of the human speech. For example, the characteristics of a segment in the audio of a media asset containing human speech may be compared (e.g., via control circuitry 604 (FIG. 6)) to audio fingerprints of a variety of dialects in different languages to determine an accent type of the speaker. In some embodiments, the media guidance application may utilize constraints to focus the search on more probable accent types. For example, in a movie in English, the media guidance application may search (e.g., via control circuitry 604 (FIG. 6)) for only English accent types. Alternatively or additionally, the media guidance application may search (e.g., via control circuitry 604 (FIG. 6)) through metadata associated with the media asset to determine a probable accent type. For example, a movie about hockey is likely to contain a Canadian accent.

Process 1200 continues to 1206, where the media guidance application compares (e.g., via control circuitry 604 (FIG. 6)) the first accent type of the human speech with preferences stored in a user profile. For example, the media guidance application may retrieve (e.g., via control circuitry 604 (FIG. 6)) a user profile associated with a user (e.g., consuming a media asset) from storage (e.g., storage 608 (FIG. 6)) or a remote server (e.g., media guidance data source 718 accessible via communications network 714 (FIG. 7)). The media guidance application may then retrieve (e.g., via control circuitry 604 (FIG. 6)) stored characteristics and preferences of the user and determine whether they relate to the first accent type. For example, the media guidance application may determine (e.g., via control circuitry 604 (FIG. 6)) that the user's native accent type is American English from a user preference, which is different than the detected accent type (e.g., Canadian English). In some embodiments, the media guidance application may access (e.g., via control circuitry 604 (FIG. 6)) a data structure storing user preferences related to how easily a user understands different accent types (e.g., values ranking on a scale of 1 to 10 how well a user understands different accents).

Process 1200 continues to 1208, where the media guidance application, based on the preferences stored in the user profile, determines (e.g., via control circuitry 604 (FIG. 6)) an amount to adjust the first accent type to a second accent type. For example, the preferences may contain a value or indication of the amount to adjust the first accent type to a second accent type. As a specific example, the media guidance application may retrieve (e.g., via control circuitry 604 (FIG. 6)) a value of 2 out of 10 that a user can understand a particular accent and based on the value determine an amount to adjust the audio (e.g., to be more like the user's accent type). The media guidance application may determine (e.g., via control circuitry 604 (FIG. 6)) the amount based on a rule-set. For example, the media guidance application may store (e.g., in storage 608 (FIG. 6)) average values for how easily users who identify with one accent type can understand the detected accent type in the media asset. For example, based on a user's geographic location, demographics, or other stored information in their profile, the media guidance application may determine (e.g., via control circuitry 604 (FIG. 6)) a probable accent type for the user. The media guidance application may then determine (e.g., via control circuitry 604 (FIG. 6)) the amount based on the probable accent type of the user (e.g., from a data structure containing a plurality of average values for amounts to adjust the audio from one accent type to another). The media guidance application may then adjust (e.g., via control circuitry 604 (FIG. 6)) the audio from the detected accent type to the probable accent type of the user by the amount.

Process 1200 continues to 1210, where the media guidance application retrieves (e.g., via control circuitry 604 (FIG. 6)) replacement audio where the first accent type is adjusted by the amount to the second accent type. For example, the media guidance application may generate (e.g., via control circuitry 604 (FIG. 6)) a new phoneme based on combining a phoneme from the audio (e.g., in a media asset) and the corresponding phoneme of the second accent type. As a specific example, a Canadian English accent for the word about may correspond to the phonemes, “ah” and “boot.” If the second accent type is for American English, then the phonemes for about may be, “ah” and “bowt.” The media guidance application may determine (e.g., via control circuitry 604 (FIG. 6)) that the first “ah” phonemes are similar, but that the second needs to be modified. The media guidance application may blend (e.g., via control circuitry 604 (FIG. 6)) the two phonemes together, by percentages based on the amount (e.g., as described further below with respect to FIG. 11) in order to create a new phoneme that has characteristics of the original phoneme in the audio but is easier for the user to understand.

Process 1200 continues to 1212, where the media guidance application transmits (e.g., via control circuitry 604 (FIG. 6)) the replacement audio for playback. For example, upon retrieving replacement audio for each phoneme determined to need adjustment by the media guidance application, the media guidance application may transmit (e.g., via control circuitry 604 (FIG. 6)) the replacement audio instead of each phoneme that was adjusted. For example, the media guidance application may transmit (e.g., via control circuitry 604 (FIG. 6)) the audio of the partitioned phonemes (e.g., ordered by time code), but transmit replacement audio instead of the original partitioned phoneme for any phoneme that was adjusted.

It is contemplated that the steps or descriptions of each of FIGS. 8-12 may be used with any other embodiment of this disclosure. In addition, the steps and descriptions described in relation to FIGS. 8-12 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 6-7 could be used to perform one or more of the steps in FIGS. 8-12.

While some portions of this disclosure may make reference to “convention,” any such reference is merely for the purpose of providing context to the invention(s) of the instant disclosure, and does not form any admission as to what constitutes the state of the art.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. (canceled)

2. A method for modifying accents in speech, the method comprising:
determining that audio contains human speech;
analyzing the human speech to determine a first accent type of the human speech;
comparing the first accent type of the human speech with preferences stored in a user profile;
based on the preferences stored in the user profile, determining an amount to adjust the first accent type to a second accent type;
partitioning the human speech into a series of phonemes;
analyzing audio properties of each phoneme of the series of phonemes;
determining, based on the audio properties of each phoneme of the series of phonemes, a respective similarity for each phoneme of the series of phonemes, the respective similarity indicating a percent similarity between each phoneme of the series of phonemes and a corresponding phoneme of the second accent type;
comparing the respective similarity for each phoneme of the series of phonemes to the amount;
based on the comparing, determining a subset of phonemes of the series of phonemes to adjust;
retrieving replacement audio for each phoneme of the subset of phonemes, wherein the replacement audio replaces each phoneme of the subset of phonemes with a new phoneme with the similarity greater than the amount, and wherein the similarity is less than complete similarity with the corresponding phoneme of the second accent type; and
transmitting the replacement audio for playback.

3. The method of claim 2, wherein analyzing the human speech to determine the first accent type of the human speech comprises:
retrieving, from the audio containing the human speech, a time code corresponding to a start time of the human speech;
comparing the time code to a plurality of time codes stored in a database, wherein each time code of the plurality of time codes stored in the database is associated with an accent type of a plurality of accent types;
determining that the time code matches a first time code stored in the database; and
retrieving the first accent type from a field associated with the first time code.

4. The method of claim 2, wherein analyzing the human speech to determine the first accent type of the human speech comprises:
comparing the audio properties of a first phoneme of the series of phonemes with the audio properties of a respective corresponding phoneme of each accent type of a plurality of candidate accent types;
determining, based on comparing the first phoneme with the respective corresponding phoneme of each accent type, a similarity value between the first phoneme and the respective corresponding phoneme of each accent type;
ranking the similarity value between the first phoneme and the respective corresponding phoneme of each accent type; and
based on the ranking, determining the first accent type corresponds to the human speech.

5. The method of claim 2, wherein determining the amount to adjust the first accent type to the second accent type comprises:
retrieving the user profile;
retrieving, from the user profile, a value indicating that a first preference of the preferences stored in the user profile is for the second accent type;
accessing a data structure in the user profile containing a plurality of amounts to adjust accent types to the second accent type; and
retrieving, from the data structure, the amount to adjust the first accent type to the second accent type.

6. The method of claim 2, wherein determining the respective similarity comprises:
comparing the audio properties of each phoneme of the series of phonemes with the corresponding phoneme of the second accent type by:
generating, based on analyzing the audio properties of each phoneme of the series of phonemes, first values for frequency and amplitude as functions of time for each phoneme of the series of phonemes; and
comparing the first values for each phoneme of the series of phonemes with second values for the corresponding phoneme of the second accent type;
determining a degree to which the first values and second values correspond; and
determining the respective similarity for each phoneme of the series of phonemes based on the degree.

7. The method of claim 2, further comprising:
determining a textual representation of each phoneme of the series of phonemes;
accessing an accent database, wherein the accent database contains a first plurality of fields each containing the textual representation of a phoneme of the first accent type, wherein each of the first plurality of fields is associated with a field of a second plurality of fields containing the textual representation of a phoneme of the second accent type;
comparing the textual representation of each phoneme of the series of phonemes with the first plurality of fields;
determining, based on the comparing, a first respective field of the first plurality of fields that matches the textual representation of each phoneme of the series of phonemes; and
retrieving the textual representation of the phoneme of the second accent type corresponding to each phoneme of the series of phonemes from a second respective field of the second plurality of fields, wherein each second respective field is associated with a first respective field.

8. The method of claim 2, further comprising:
generating for display an interactive dial, wherein the interactive dial indicates the amount to adjust the first accent type to the second accent type;
receiving a user input to adjust the amount to be more similar to one of the first accent type and the second accent type; and
based on receiving the user input, updating the amount to adjust the first accent type to the second accent type.

9. The method of claim 2, wherein retrieving the replacement audio for each phoneme of the subset of phonemes comprises:
retrieving a corresponding phoneme of the second accent type for each phoneme of the subset of phonemes;
aligning a first audio clip of each phoneme of the subset of phonemes with a second respective audio clip of the corresponding phoneme of the second accent type; and
generating the new phoneme replacing each phoneme of the subset by:
determining, based on the determined respective similarity for each phoneme of the series of phonemes indicating the percent similarity between each phoneme of the series of phonemes and the corresponding phoneme of the second accent type, a mixing value for each phoneme of the subset of phonemes; and
combining the first audio clip of each phoneme of the subset of phonemes with the second respective audio clip of the corresponding phoneme of the second accent type, wherein the first audio clip is scaled by the mixing value.

10. The method of claim 2, wherein retrieving the replacement audio for each phoneme of the subset of phonemes comprises:
accessing a database containing a plurality of replacement audio, wherein each replacement audio of the plurality of replacement audio is associated with a similarity between the first accent type and the second accent type; and
retrieving, from the database, replacement audio for each phoneme of the subset of phonemes, wherein each replacement audio corresponds to a similarity that is greater than the amount.

11. The method of claim 2, wherein partitioning the human speech into the series of phonemes comprises:
analyzing amplitude of the audio that contains the human speech;
determining time codes in the audio where the amplitude is below a threshold amplitude; and
extracting segments of the audio between consecutive ordered time codes of the determined time codes, wherein each extracted segment includes a phoneme of the series of phonemes.

12. A system for modifying accents in speech, the system comprising:
storage circuitry configured to:
store a user profile with preferences of a user;
control circuitry configured to:
determine that audio contains human speech;
analyze the human speech to determine a first accent type of the human speech;
compare the first accent type of the human speech with the preferences stored in the user profile;
based on the preferences stored in the user profile, determine an amount to adjust the first accent type to a second accent type;
partition the human speech into a series of phonemes;
analyze audio properties of each phoneme of the series of phonemes;
determine, based on the audio properties of each phoneme of the series of phonemes, a respective similarity for each phoneme of the series of phonemes, the respective similarity indicating a percent similarity between each phoneme of the series of phonemes and a corresponding phoneme of the second accent type;
compare the respective similarity for each phoneme of the series of phonemes to the amount;
based on the comparing, determine a subset of phonemes of the series of phonemes to adjust;
retrieve replacement audio for each phoneme of the subset of phonemes, wherein the replacement audio replaces each phoneme of the subset of phonemes with a new phoneme with the similarity greater than the amount, and wherein the similarity is less than complete similarity with the corresponding phoneme of the second accent type; and
transmit the replacement audio for playback.

13. The system of claim 12, wherein the control circuitry is further configured, when analyzing the human speech to determine the first accent type of the human speech, to:
retrieve, from the audio containing the human speech, a time code corresponding to a start time of the human speech;
compare the time code to a plurality of time codes stored in a database, wherein each time code of the plurality of time codes stored in the database is associated with an accent type of a plurality of accent types;
determine that the time code matches a first time code stored in the database; and
retrieve the first accent type from a field associated with the first time code.

14. The system of claim 12, wherein the control circuitry is further configured, when analyzing the human speech to determine the first accent type of the human speech, to:
compare the audio properties of a first phoneme of the series of phonemes with the audio properties of a respective corresponding phoneme of each accent type of a plurality of candidate accent types;
determine, based on comparing the first phoneme with the respective corresponding phoneme of each accent type, a similarity value between the first phoneme and the respective corresponding phoneme of each accent type;
rank the similarity value between the first phoneme and the respective corresponding phoneme of each accent type; and
based on the ranking, determine the first accent type corresponds to the human speech.

15. The system of claim 12, wherein the control circuitry is further configured, when determining the amount to adjust the first accent type to the second accent type, to:
retrieve the user profile;
retrieve, from the user profile, a value indicating that a first preference of the preferences stored in the user profile is for the second accent type;
access a data structure in the user profile containing a plurality of amounts to adjust accent types to the second accent type; and
retrieve, from the data structure, the amount to adjust the first accent type to the second accent type.

16. The system of claim 12, wherein the control circuitry is further configured, when determining the respective similarity, to:
compare the audio properties of each phoneme of the series of phonemes with the corresponding phoneme of the second accent type by:
generating, based on analyzing the audio properties of each phoneme of the series of phonemes, first values for frequency and amplitude as functions of time for each phoneme of the series of phonemes; and
comparing the first values for each phoneme of the series of phonemes with second values for the corresponding phoneme of the second accent type;
determine a degree to which the first values and second values correspond; and
determine the respective similarity for each phoneme of the series of phonemes based on the degree.

17. The system of claim 12, wherein the control circuitry is further configured to:
determine a textual representation of each phoneme of the series of phonemes;
access an accent database, wherein the accent database contains a first plurality of fields each containing the textual representation of a phoneme of the first accent type, wherein each of the first plurality of fields is associated with a field of a second plurality of fields containing the textual representation of a phoneme of the second accent type;
compare the textual representation of each phoneme of the series of phonemes with the first plurality of fields;
determine, based on the comparing, a first respective field of the first plurality of fields that matches the textual representation of each phoneme of the series of phonemes; and
retrieve the textual representation of the phoneme of the second accent type corresponding to each phoneme of the series of phonemes from a second respective field of the second plurality of fields, wherein each second respective field is associated with a first respective field.

18. The system of claim 12, wherein the control circuitry is further configured to:
generate for display an interactive dial, wherein the interactive dial indicates the amount to adjust the first accent type to the second accent type;
receive a user input to adjust the amount to be more similar to one of the first accent type and the second accent type; and
based on receiving the user input, update the amount to adjust the first accent type to the second accent type.

19. The system of claim 12, wherein the control circuitry is further configured, when retrieving the replacement audio for each phoneme of the subset of phonemes, to:
retrieve a corresponding phoneme of the second accent type for each phoneme of the subset of phonemes;
align a first audio clip of each phoneme of the subset of phonemes with a second respective audio clip of the corresponding phoneme of the second accent type; and
generate the new phoneme replacing each phoneme of the subset by:
determining, based on the determined respective similarity for each phoneme of the series of phonemes indicating the percent similarity between each phoneme of the series of phonemes and the corresponding phoneme of the second accent type, a mixing value for each phoneme of the subset of phonemes; and
combining the first audio clip of each phoneme of the subset of phonemes with the second respective audio clip of the corresponding phoneme of the second accent type, wherein the first audio clip is scaled by the mixing value.

20. The system of claim 12, wherein the control circuitry is further configured, when retrieving the replacement audio for each phoneme of the subset of phonemes, to:
access a database containing a plurality of replacement audio, wherein each replacement audio of the plurality of replacement audio is associated with a similarity between the first accent type and the second accent type; and
retrieve, from the database, replacement audio for each phoneme of the subset of phonemes, wherein each replacement audio corresponds to a similarity that is greater than the amount.

21. The system of claim 12, wherein the control circuitry is further configured, when partitioning the human speech into the series of phonemes, to:
analyze amplitude of the audio that contains the human speech;
determine time codes in the audio where the amplitude is below a threshold amplitude; and
extract segments of the audio between consecutive ordered time codes of the determined time codes, wherein each extracted segment includes a phoneme of the series of phonemes.

22-51. (canceled)
